(19) United States
(12) Patent Application Publication
(10) Pub. No.: US 2021/0408515 A1
(43) Pub. Date: Dec. 30, 2021

(54) HEALING AND MORPHOGENESIS OF STRUCTURAL METAL FOAMS AND OTHER MATRIX MATERIALS

(71) Applicant: THE TRUSTEES OF THE UNIVERSITY OF PENNSYLVANIA, Philadelphia, PA (US)

(72) Inventors: James Henry PIKUL, Philadelphia, PA (US); Zakaria H'SAIN, Philadelphia, PA (US)

(21) Appl. No.: 17/291,657

(22) PCT Filed: Nov. 6, 2019
(86) PCT No.: PCT/US2019/060087

§ 371 Date: May 6, 2021

Related U.S. Application Data
(60) Provisional application No. 62/756,243, filed on Nov. 6, 2018.

(51) Int. Cl. H01M 4/04; H01M 10/04; H01M 4/80

(52) U.S. Cl. CPC H01M 4/0402; H01M 2300/0082; H01M 4/808; H01M 10/04

(57) ABSTRACT

Provided are adaptive materials that include an electrically conductive matrix material defining a plurality of voids; and an electrolyte disposed in at least some of the voids, the electrolyte comprising at least an ion of a first metal. Also provided are related methods of effecting self-healing in the disclosed materials. Further provided are methods of effecting repeated healing in metallic materials.

### RELATED APPLICATIONS

The present application claims priority to and the benefit of U.S. patent application No. 62/756,243, “Healing And Morphogenesis Of Structural Metal Foams And Other Matrix Materials” (filed Nov. 6, 2018), the entirety of which application is incorporated herein by reference for any and all purposes.

### TECHNICAL FIELD

The present disclosure relates to the field of self-healing and adaptive materials and to the field of electrodeposition of metals.

### BACKGROUND

A variety of materials with self-healing properties have been conceived and developed. Polymers are by far the most studied class of these materials. Earlier development focused on designing polymers with embedded microscale capsules that rupture upon the fracture of the polymer and release a liquid monomer. Then, a catalyst induces the polymerization of the monomer in the crack, which leads to crack closure and self-healing. This technique, however, is not repeatable, as a second crack at the same location cannot be self-healed because the capsules in its vicinity were depleted to close the first crack. In addition, this approach is not conducive to healing metals, which can require elevated temperatures near the metal's melting point to increase metal transport and to heal cracks. Accordingly, there is a long-felt need in the art for improved self-healing materials and related methods.

### SUMMARY

Materials found in nature can change their morphology and material properties to achieve an incredible range of functionalities. This ability to dynamically change morphology and composition without failure, which one can refer to as dynamic morphogenesis, enables efficient use of limited resources, minimizes weight to reduce energy consumption for walking and running, and enables effective healing when damaged. Despite these desirable functionalities, scientists and engineers have yet to develop structural materials with similar dynamic morphogenesis. Structural materials made today are fixed and designed to withstand all current and predicted future loading cases.

In natural materials, changes in morphology and composition, in general, are enabled by the transport of mass and energy (oxygen, ATP, nutrients, and cells, for example) through cellular structures to and from the areas in which morphogenesis is occurring. These cellular structures have a continuous hard phase (ceramic or cellulose, for example) and a continuous pore structure. The continuous hard phase provides a structural network for supporting mechanical loading, while the continuous pores are critically important for (1) housing functional active materials that respond to environmental stimuli and (2) allowing mass and energy transport to and from locations of morphogenesis. This strategy of morphogenesis, through mass and energy transport, is significantly different than the strategy used by engineers in synthetic self-healing materials, where the capability for self-healing is locally stored. Although these self-healing systems based on local storage have demonstrated impressive capabilities, they are largely not applicable to hard materials, like metals or ceramics, can only be healed once (which prevents continuous adaptation and morphogenesis), and are not analogous to biological morphogenesis.

The present disclosure applies mass and energy transport mediated through electrochemical reactions to affect the dynamic morphogenesis of cellular metals, and how the resulting pore structure affects the mechanical response of the material. The disclosed materials are a new class of structural materials that, like bone, improve mechanical and chemical functionality in response to the way the material is used. Similar to bone, a matrix material acts as a structural material that distributes mechanical loads and that can be chemically modified to respond to the local environment.

As one non-limiting embodiment, to take advantage of the fast transport of metal species in electrolytes, one can infiltrate an electrolyte into the pores of high strength cellular nickel and use electrochemistry to drive chemical changes. One can apply potentials to different parts of a cellular nickel foam. Areas with negative potential will plate nickel (reduction). Areas with positive potential (oxidation) will etch nickel. In addition to changing the local density and morphology of the cellular nickel, the cellular nickel can be coated with additional materials to impart unique functionality. Using this approach, one can will fuse struts in cellular nickel to enable rapid room temperature healing.

In one aspect, the present disclosure provides adaptive material systems, comprising: an electrically conductive matrix material defining a plurality of voids; and an electrolyte disposed in at least some of the voids, the electrolyte comprising at least an ion of a first metal.

Also provided are methods, comprising: effecting application of an electrical current to a system according to the present disclosure so as to give rise to deposition of an amount of the first metal on a cathode region of the electrically conductive matrix material, the cathode region being in fluid communication with the electrolyte.

Further provided are methods, comprising: applying a force to a system according to the present disclosure so as to give rise to a fracture of the matrix material; and effecting application of an electrical current to the system so as to give rise to deposition of an amount of the first metal on a cathode region of the electrically conductive matrix material, the cathode region being at least partially disposed along the fracture of the matrix material.

Also provided are methods, comprising: effecting application of an electrical current to an electrolyte comprising a first metal ion, the application being effected so as to give rise to deposition of an amount of the first metal on a cathode region of an electrically conductive matrix material defining a plurality of voids, the cathode region being in fluid communication with the electrolyte.

Further disclosed are adaptive materials, comprising: an electrically conductive matrix material defining a plurality of voids and the matrix material defining a grain size, and an amount of a first metal deposited on the matrix material, the amount of the first metal defining a grain size that differs from the grain size of the matrix material.

Further provided are methods, comprising: effecting application of a negative potential to an electrolyte comprising a first metal ion, the application being effected so as to give rise to deposition of a deposited amount of the first metal on a cathode region of an electrically conductive matrix material defining a plurality of voids, the cathode region being in fluid communication with the electrolyte, the cathode region being disposed within a fractured region of the electrically conductive matrix material; effecting application of a positive potential to an electrolyte comprising a monomer, the application being effected so as to give rise to deposition of a deposited amount of the monomer on the deposited amount of the first metal, and giving rise to a monomer-derived polymer coating on the deposited amount of the first metal. Without being bound to any particular theory, the monomer (and resulting polymer) can be attached (e.g., via Van Der Waals forces, e.g., via chelation) to the surface of the metal, but this is not a requirement. Again without being bound to any particular theory or any particular embodiment, a monomer can be selected such that the monomer is soluble in the solvent (e.g., electrolyte) in which the monomer is dispersed, while the polymer derived from that monomer is not soluble in the solvent.

Also provided are adaptive material systems, comprising: an electrically conductive matrix material defining a plurality of voids; an electrolyte disposed in at least some of the voids, the electrolyte comprising at least an ion of a first metal, the electrolyte further comprising an amount of a monomer that gives rise to a dielectric polymer; and a source of one or both of a positive electrical potential and a negative electrical potential.

Additionally disclosed are adaptive material systems, comprising: an electrically conductive matrix material defining a plurality of voids; an electrolyte disposed in at least some of the voids, the electrolyte comprising at least an ion of a first metal, the electrolyte further comprising an amount of a monomer that gives rise to a dielectric polymer; and a source of one or both of a positive electrical potential and a negative electrical potential.

Also provided are methods, comprising: effecting application of a potential to an electrolyte comprising a first metal ion, the application being effected so as to give rise to deposition of a deposited amount of the first metal on a cathode region of an electrically conductive matrix material defining a plurality of voids, the cathode region being in fluid communication with the electrolyte, the cathode region being disposed within a fractured region of the electrically conductive matrix material; effecting application of a potential to an electrolyte comprising a monomer, the application being effected so as to give rise to deposition of a deposited amount of the monomer about the deposited amount of the first metal, a monomer-derived polymer coating on the deposited amount of the first metal.

Further provided are workpieces, comprising: an electrically conductive matrix material defining a plurality of voids, a dielectric coating surmounting the electrically conductive matrix material, an opening formed in the dielectric coating, the electrically material defining two edges physically separate from one another, the opening placing the two edges into fluid communication with the environment exterior to the dielectric coating.

Also provided are workpieces, comprising: an electrically conductive matrix material defining a plurality of voids, the electrically material defining two edges physically separate from one another, an amount of deposited metal connecting the two edges, and a dielectric coating surmounting the matrix material and the deposited metal.

Further provided are adaptive material systems, comprising: an electrically conductive matrix material defining a plurality of voids; a detection device configured to detect a fracture within the matrix material; and a supply of an electrolyte comprising at least an ion of a first metal, the electrolyte optionally comprising an amount of a monomer, and the system being configured to contact the matrix material with the electrolyte upon detection of a fracture within the matrix material, and the system being configured to apply a potential to the matrix material so as to effect deposition of an amount of the first metal onto a detected fracture.

Also provided are adaptive material systems, comprising: a metallic matrix material; an electrolyte sealably contained within a void within the metallic matrix material, the electrolyte comprising at least an ion of a first metal; and a source of a potential, the source being configured to effect plating of the first metal onto a fractured region of the metallic matrix material.

Further disclosed are adaptive material systems, comprising: a metallic matrix material; a solid or semisolid electrolyte disposed about the metallic matrix material, the solid or semisolid electrolyte comprising at least an ion of a first metal; and a source of a potential configured to effect plating of the first metal onto a fractured region of the metallic matrix material.

Further provided are adaptive material systems, comprising: a metallic matrix material; and an electrolyte comprising at least an ion of a first metal, the system being configured to deliver the electrolyte to a fractured region of the metallic matrix material.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides a geometry of a simulated electrochemical cell. Boundaries representing the anode, the cathode and a constant concentration condition are highlighted in red, blue and purple respectively. The side surfaces of the broken strut are coated with a passivating layer; hence no electrochemical reactions occur on those surfaces.

FIG. 2 provides a SEM image (a) and photograph (b) of the Ni foam used in this study (scale bar represents 5 mm). Cross-sectional SEM image of ALD alumina coating on Ni foam (c). The coating thickness is approximately 150 nm.

FIG. 3 provides representative constitutive mechanical behavior of nickel foam with SEM insets showing cracks in regime II samples and regime III samples (scale bars represent 300 μm).

FIG. 4 provides representative pre-healing and post-healing stress-strain plots of regime III samples healed using electrodeposition for 1 h (a), 2 h (b), 3.5 h (c) and 5 h (d). Pre-healing curves are plotted in line form while post-healing curves are plotted using dots.

FIG. 5 provides representative pre-healing and post-healing stress-strain plots of regime II samples healed using electrodeposition for 1 h (a), 3.5 h (b) and 5 h (c).

FIG. 6 provides representative healing efficiency with respect to electrical energy dispensed during healing for regime III samples (a) and regime II samples (b).

FIG. 7 provides a representative SEM image showing nanocrystalline grains in Ni electrodeposited on Ni foam (a) compared to micron-sized grains in uncoated Ni foam (b). Both scale bars represent 10 μm.

FIG. 8 provides representative current measured during nickel electrodeposition on uncoated nickel foam and nickel foam with various passivation coatings (a). Cracking in ALD alumina coating observed by SEM after tensile testing (b). Scale bar represents 50 μm.

FIG. 9 provides a representative concentration distribution close to the cathode (the two strut surfaces highlighted in blue in FIG. 1) at t=0 s, t=120 s, t=1200 s and t=2280 s. Mesh deformation allows a visualization of the nickel film profile on the two strut surfaces at each time instant.

FIG. 10 provides a representative profile of electrodeposited nickel coating on blue-colored cathode boundary at time instants incremented by 150 s. Electrodeposited nickel exhibits a non-uniform growth rate across time and position on the blue surface.

FIG. 11 provides a representative diffusive flux of nickel ions close to the cathode at t=30 s, t=300 s, t=1200 s and t=2280 s.

FIG. 12 provides a representative probability of achieving 100% stress and toughness healing efficiency in healed Ni foams subjected to micro-scale cracking (dashed lines) and large-scale cracking (full lines).

FIG. 13 provides a representative Gaussian distribution of stress healing efficiency of Ni foams subjected to micro-scale cracking and healed for varying time durations.

FIG. 14 provides representative SEM images showing the same strut in a coated Ni foam before (left panel) and after healing (right panel). The passivating coating limits nickel deposition to cracked areas.

FIG. 15 provides representative Ni foams with two different crack configurations were obtained by halting tensile testing at two distinct regimes

FIG. 16 provides representative SEM images showing nickel deposits along healed large-scale cracks in Ni foams.

FIG. 17 provides representative transport-mediated healing in cellular metals inspired by bone. a) Illustration of hematoma formation during bone fracture. Healing occurs by transporting cells and nutrients through the cellular bone to the fracture location. b) Illustration of our transport-mediated approach for healing polymer-coated cellular nickel. Healing occurs by transporting electrons through the nickel and nickel ions through the electrolyte in the pores to the healing location. The nickel ions electrochemically reduce, and new nickel is electrodeposited. c) SEM image of a fractured nickel strut. Exposed nickel and the plastic coating are false-colored with blue and brown, and the background brightened to highlight the strut. d) The same strut in (c) after healing. Electrodeposited nickel is false-colored green. e) Stress-strain data of a cellular nickel sample. We characterize the healing effectiveness of cellular nickel subjected to three damage types: plastic deformation at 3% strain (P), failure beyond the ultimate strain (F1), and local failure by scission (F2).

FIG. 18 provides representative healing of cellular nickel with scission damage (F2). Photograph (a) and SEM micrograph (b) of cellular nickel with F2 failure before healing. c) SEM micrograph of healed cellular nickel showing nickel deposits isolated to the scission vicinity. d-f) Stress-strain data of F2 cellular nickel healed with 0 J, 500 J, and 1,500 J of electrical energy. Data from a pristine cellular nickel is included in (d) for reference. g) Strength and toughness healing efficiency, ea and eu, plotted versus electrical energy input. h) The probability of attaining a target strength healing efficiency plotted versus electrical energy input. Connected lines correspond to 50, 80, and 100% healing efficiency. f) Fraction of samples that fractured outside the healed scission (B samples) compared to samples fractured at the scission (A samples) as a function of electrical energy input.

FIG. 19 provides representative healing of cellular nickel subjected to tensile loading near failure (F1). Photograph (a) and SEM micrograph (b) of F1 nickel foam before healing. c) SEM micrograph of F1 foam healed with 250 J. d-g) Stress-strain data of F2 cellular nickel healed with 0 J, 250 J, 2,500 J and 3,500 J of electrical energy. Data from a pristine cellular nickel is included in (d) for reference. h) Toughness and strength healing efficiency plotted with respect to electrical energy input. i) The probability of attaining a target strength healing efficiency (50, 80 and 100%) plotted versus electrical energy input.

FIG. 20 provides representative healing of plastically-deformed cellular nickel (P). a) Stress-strain data for the first loading of P cellular nickel, followed by stress-strain data for the second loading after healing with 0 J (no healing) and 1,500 J of energy input. b) Strengthening factor plotted versus electrical energy input. c) The probability of attaining a target strengthening factor (0.8, 1.0 and 1.2) plotted versus electrical energy input. d) SEM micrograph of P cellular nickel before healing. e) SEM micrograph of P cellular nickel after healing. f) SEM micrograph of post-healed fracture in a P cellular nickel strut. g) Temperature during healing plotted versus healing energy input per mm crack length for our work, different reports of metal healing, and two welding methods. The numbers correspond to the references for each data range.

FIG. 21 provides a) stress-strain data of F2 cellular nickel healed with 0 J, 250 J, 900 J, 1,500 J, and 2,100 J of electrical energy. b) Stress-strain data of twenty pristine cellular nickel samples used to calculate the healing efficiencies of F2 samples. Average tensile strength is 2.1432 MPa and average toughness is 97,178 J/m³. c) SEM images of F2 sample before (image to the right) and after healing (scale bars: 1 mm).

FIG. 22 provides a) stress-strain data of F1 cellular nickel in the pristine state (dashed lines) and after healing with 0 J, 250 J, 1,000 J, 1,500 J, 2,500 J, and 3,500 J of electrical energy (continuous lines). SEM micrographs of microscale cracks in F1 cellular nickel after tensile failure (scale bar: 100 μm) (b) and F1 cellular nickel healed with 2,500 J of electrical energy input (scale bar: 1 mm) (c).

FIG. 23 provides a) stress-strain data of P cellular nickel healed with 100 J, 360 J, 900 J, 1,500 J, and 2,100 J of electrical energy. b) Stress-strain data of ten non-healed P cellular nickel samples used to calculate the strengthening factors of P samples. Average tensile strength is 1.8578 MPa. c) SEM image of a nickel strut in a P sample before healing (image to the left), and another strut after healing (scale bars: 100 μm).

FIG. 24 provides representative probability density functions of strength healing efficiency at each energy input for F2 samples (a), F1 samples (b), and P samples (c). d) Fit data for the Gaussian distributions shown in (a), (b) and (c).

FIG. 25 provides a) X-ray diffraction spectrum of electrodeposited nickel. SEM micrographs of electrodeposited nickel (b) and a pristine nickel surface in the cellular nickel (c) (scale bars: 10 μm).

FIG. 26 provides an exemplary 3D printed device used for healing of cellular nickel samples (dimensions are in inches).

FIG. 27 provides exemplary images of embodiments of the disclosure technology, showing (from left to right) an example setup for healing fractured nickel foam, views of fractured and healed nickel foam, and pristine, fractured, and healed dog-bones of nickel foam.

FIG. 28 provides exemplary elements (metals and metalloids) that can be electrodeposited with current technology; alloys containing two or more of these elements can be electrodeposited as well.

FIG. 29 provides a representative schematic of an example process according to the present disclosure;

FIG. 30 provides some example (non-limiting) polymers that can be used as insulating polymers for the disclosed technology;

FIG. 31 provides a polymer-coated working electrode, made according to the disclosed technology.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Many biological organisms and systems, such as bones and mollusks, possess regenerative or self-healing capabilities, which not only allow them to regain their mechanical strength and geometric integrity after damage or fracture, but also enable them to efficiently redistribute matter in response to dynamic deformation. In contrast, barring recently-developed self-healing materials, synthetic structural materials cannot autonomously adapt their geometries and local densities to dynamic loading scenarios. These materials also cannot self-heal to recover their mechanical properties once damaged. This inability to autonomously respond to mechanical stress and structural damage, thus, means that materials need to be repaired and monitored regularly, which translates to high costs and short lifetimes. Moreover, designers and engineers must conduct probabilistic and computational analyses (e.g. finite element analysis, topology optimization) to account for possible loading scenarios. They must also calculate safety factors to guard against brittle fracture and fatigue failure, which leads, in many cases, to heavy and bulky structures. Using self-healing materials instead can lead to significantly lighter and less voluminous designs, as well as afford designers more room for error since these materials can potentially autonomously adapt to even the most extreme loading conditions.

A variety of materials with self-healing properties have been conceived and developed. Polymers are by far the most studied class of these materials. Earlier development focused on designing polymers with embedded microscale capsules which rupture upon the fracture of the polymer and release a liquid monomer. Then, a catalyst induces the polymerization of the monomer in the crack, which leads to crack closure and self-healing. This self-healing technique, while very effective and scalable, is not repeatable: a second crack at the same location cannot be self-healed because the capsules in its vicinity were depleted to close the first crack.

To enable repeatable self-healing in polymers, supramolecular polymers held together by moderately strong, highly directional and reversible non-covalent bonds have been developed. The mechanical strength of such polymers, therefore, emanates not from covalent bonding and chain entanglement, but from molecular/atomic interactions such as hydrogen bonds, π-π bonds, ionic bonds and metallic bonds. In the event of a crack, these supramolecular bonds conserve their “stickiness” for a certain period of time and tend to recombine (autonomously or upon application of a thermal or mechanical stimulus), thus closing the crack and healing the material. The reversible character of these bonds means that the self-healing process can be repeated many times, with little to no degradation in its efficiency. Repeatable self-healing in polymers has also been shown to be possible through sunlight-induced photopolymerization.

As for metals, repeatable and efficient self-healing has remained largely elusive. Metals present significant challenges compared to other types of materials due to the non-directional character of their bonds which may prevent preservation of the original microstructure after healing, in addition to their slow mass transport at room temperature. Hence, introducing self-healing in metals cannot rely on a direct emulation of techniques developed for polymers or ceramics. Mimicking polymer healing agent encapsulation, for instance, has been attempted in metals by using solder tubes and embedded capsules. But the necessity of thermal stimuli and the weak bonding between the solder and crack surfaces meant that these attempts were largely unsuccessful at developing a self-healing meta.

New techniques and innovative paradigms are necessary. High temperature precipitation is one relatively well-studied technique for self-healing in metals. Heat treatment in a two-phase precipitation-hardened alloy results in the precipitation of the solute atoms. Since it is more energetically favorable for the precipitates to nucleate and grow in defective regions such as voids, vacancies and dislocations, small cracks can be filled with solute atoms and healed. An example of this self-healing method is a modified steel prepared by adding boron to a standard 347 stainless steel. As nanoscale cracks start forming, the boron atoms, acting as the solute healing agent, precipitate at the crack surfaces and promote crack closure. This process, however, which was initially designed to suppress creep fracture, is driven by heat at temperatures greater than 1000 K, thus limiting its applicability. An alternative method exploits stress-driven grain boundary migration in nanocrystalline metals. Using molecular dynamics simulations, this phenomenon was shown to lead to the closure of a pre-existing nanocrack in a nickel bicrystal when a shear stress is applied parallel to the crack plane. Although grain boundary migration can also lead to crack advance, especially in the case of an unstable crack, the simulations showed that it is, in fact, more likely to close them even under continuous tensile loading.

This disclosure shows that cellular metallic materials can be healed with high (e.g., 174%) efficiency by electrodeposition, so that their yield strength after healing exceeds their original strength. To demonstrate this in a non-limiting way, open-cell nickel foams coated with a passivating conformal thin film were subjected to tensile testing, healed via electrodeposition at constant voltage in a nickel sulfamate electrolyte, then tested in tension again. The mechanical constitutive behavior of samples before and after healing is compared, and the effect of electrodeposition duration on mechanical properties and healing efficiency is studied. Moreover, the morphology of the electrodeposited nickel is characterized using scanning electron microscopy to glean insights into factors such as morphology and grain size which may affect the mechanics of the healed samples. A Multiphysics finite element model can be used to simulate the kinetics and mass transport phenomena governing nickel electrodeposition to heal a representative fractured nickel foam strut.

### Experimental Methods

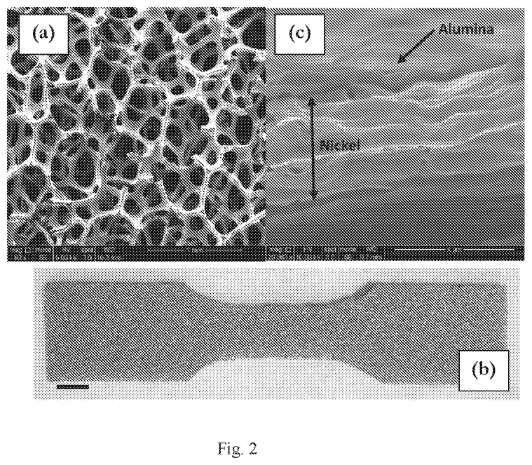

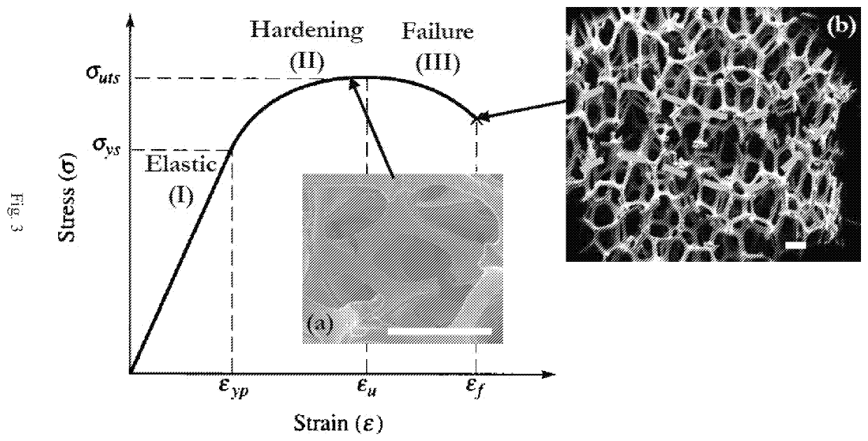

Nickel foam (MTI Corp.), as pictured in FIG. 2(a), was selected as a materials platform for this study. Samples were cut in the dog-bone configuration (FIG. 2(c)), immersed for 1 hour in a solution containing methanol (96%), ultrapure water (6%), hydrochloric acid (0.5%) and nitric acid (0.5%), then conformally coated with an approximately 150 nm-thick layer of alumina (FIG. 3(b)) using atomic layer deposition (ALD). ALD was performed in a Cambridge Nanotech Savannah 5200 reactor at 150° C. using trimethylaluminum and water as precursors. The use of alumina, which is a good electrical insulator used in passivation layers and corrosion resistant coatings, was intended to prevent nickel electrodeposition in areas other than the crack surfaces during healing. Therefore, healing can be rendered more effective since most or all nickel is deposited on the crack surfaces and broken struts in the nickel foam.

The experimental procedure of this study consisted of conducting a first tensile testing, healing the cracked samples using electrodeposition, then conducting a second tensile testing to assess the effectiveness of the healing. Tensile testing was performed using an MTS Criterion Model 43 equipped with a 50 kN load cell. The dogbone-shaped samples were loaded at a speed of 0.10 in/min (0.042 mm/s) which corresponds to a strain rate of approximately 0.001 s⁻¹. Healing was conducted via constant-voltage electrodeposition, controlled by a BioLogic SP-300 potentiostat/galvanostat. The electrolytic cell was composed of a working electrode (damaged nickel foam sample) and a reference electrode (pure nickel plate) in a commercial nickel sulfamate electrolyte (Technic, Inc.). The electrodeposition was performed at room temperature with no electrolyte agitation. Voltage was maintained at −1.8 V with respect to the reference electrode.

To characterize the ALD alumina coating and the surface morphology of the nickel foam samples before and after healing, scanning electron microscopy was performed using a Quanta 600 FEG E-SEM under high vacuum.

Computational Methods

A 2-D model of a broken nickel foam strut during healing was constructed in COMSOL Multiphysics 5.3 using the electrodeposition module. Equations governing mass transport and electrochemical reaction kinetics were solved, first, for a steady state initial case, then, for a time dependent case using the results of the first step as initial values.

Geometry and Boundary Conditions

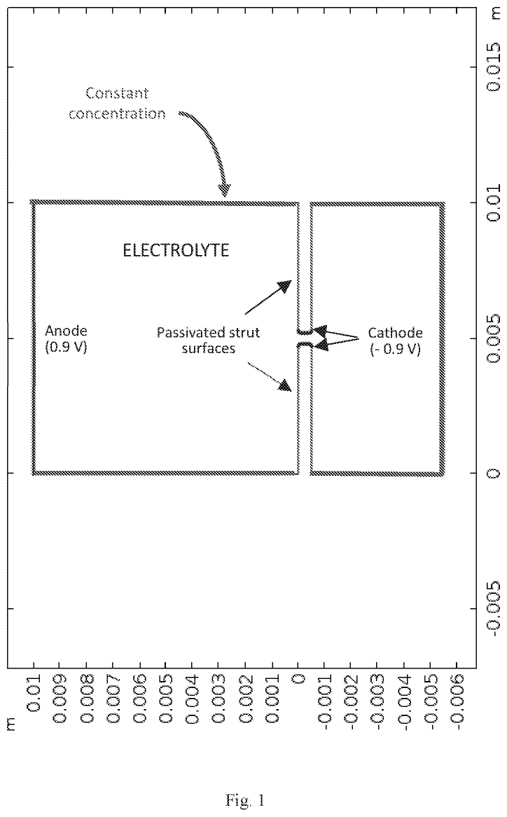

FIG. 1 shows an exemplary geometry. The upper (red) surface is the anode (pure nickel plate) and the two lower (blue) surfaces are the cathode (two crack surfaces in a 500 μm-thick nickel foam strut). The large domain is the electrolyte, which contains Ni′ ions with an initial bulk concentration of 1.4 M. This concentration is approximately the same as in commercial nickel sulfamate solutions, though this is not a requirement. NH₂SO₃ ions are used as a second species in the solution to enforce electroneutrality. The presence of boric acid, hydronium ions and chloride ions is neglected because their concentrations is significantly smaller than the concentrations of nickel and sulfamate ions.

A constant potential of −0.9 V is set at the two cathode surfaces, and the potential is set as 0.9 V on the anode surface. A constant concentration is set at the boundaries highlighted in purple, as shown in FIG. 1, to simulate a large electrolyte volume and avoid rapid nickel ion depletion during the time-dependent study. Furthermore, to account for corrosion at the anode and electrodeposition at the cathode, mesh deformation is allowed on both electrode surfaces.

Physics and Governing Equations

In the electrolyte, the net current density can be described as the sum of ionic fluxes (Eq. 1), with iₗ the current density vector, F Faraday's constant, and Nᵢ and zᵢ corresponding to the flux and charge number of species i.

$${i}_{l} = F {\sum }_{i} {z}_{i} {N}_{i} \qquad ( 1 )$$

The flux of ions in the electrolyte is described using the Nernst-Planck equation (Eq. 2) which combines the contributions of concentration-driven diffusion and charge-driven migration (convection is not relevant in this case). cᵢ represents the concentration of the ion i, Dᵢ the diffusion coefficient, uᵢ its mobility, ϕₗ the electrolyte potential.

Nᵢ=−Dᵢ∇cᵢ−zᵢuᵢcᵢF∇ϕₗ (2)

Combining Eq. 1 and Eq. 2 yields an expression for the current density in the electrolyte.

$${i}_{l} = - F ( ∇ {\sum }_{i} {z}_{i} {D}_{i} {c}_{i} ) - {F}^{2} ∇ {ϕ}_{l} {\sum }_{i} {z}_{i}^{2} {u}_{i} {c}_{i} \qquad ( 3 )$$

The Nernst-Einstein equation relates the mobility uᵢ to the diffusion coefficient, which simplifies Eq. 3 by requiring less inputs.

$${u}_{i} = \frac{{D}_{i}}{RT} \qquad ( 4 )$$

The tertiary current distribution, as defined in the COMSOL electrodeposition module, solves Eq. 3 explicitly for all species in the electrolyte to obtain the current density distribution. The concentration distribution is computed, first, by enforcing electroneutrality in the bulk of the electrolyte according to

$${\sum }_{i} {z}_{i} {c}_{i} = 0 \qquad ( 5 )$$

Electroneutrality breaks down in the electric boundary layer close to the electrode surface, but the electric boundary layer is not described or studied in detail in this simulation because it exists at a length scale much smaller compared to the characteristic length scale of the electrodes.

The red-ox reaction rate at the anode and cathode also affects the concentration distribution. This rate is governed by the charge transfer current density iₙ which on can model using Butler-Volmer kinetics, according to

$${i}_{n} = {i}_{0} [ exp ( \frac{{α}_{a} F}{RT} η ) - exp ( - \frac{{α}_{c} F}{RT} η ) ] , \qquad ( 6 )$$

The variables in Eq. 6 are defined below:
i₀ is the exchange current density and is set at 0.6 A/m².
αₐ and α_{c} are the apparent transfer coefficients at the cathode and anode respectively. Their values are usually between 0.2 and 2, and are set at 0.5 and 1.5 respectively.
R is the ideal gas constant (8.314 J/mol·K)
T is the operating temperature, which is set at room temperature (298 K).
F is Faraday's constant (˜96485 C/mol)
η is the overpotential measured by subtracting the electrolyte potential and the equilibrium potential from the electrode potential (Eq. 7). Here, the electrolyte potential is initially set to zero and the equilibrium potential is assumed to be zero because the two electrodes are made of the same material, nickel.

η−ϕₛ−ϕₗ−E_{eq} (7)

Mesh deformation is allowed at the cathode and anode surfaces shown in FIG. 1 to describe both nickel deposition at the cathode and corrosion at the anode. The kinetics of the electrochemical reaction, combined with the density and molar mass of nickel, allow the computation of the rate of mesh deformation, and, as a result, the rate of nickel film growth along the cathode surface.

Table 1 below contains values of the parameters used in this simulation.

TABLE 1
Parameters used in the computational study.

| Variable | Value | Unit |
|---|---|---|
| Diffusivity (nickel ions) | 1.0E−9 | m²/s |
| Diffusivity (sulfamate ions) | 1.0E−9 | m²/s |
| Charge number (nickel ions) | 2 | |
| Charge number (nickel ions) | 1 | |
| Exchange current density | 0.6 | A/m² |
| Transfer coef. (anode) | 0.5 | |
| Transfer coef. (cathode) | 1.5 | |
| Equilibrium potential | 0 | V |
| Cathode potential | −0.9 | V |
| Anode potential | 0.9 | V |
| Initial concentration (nickel ions) | 1400 | mol/m³ |

Results and Discussion

Mechanical Behavior Before and after Healing

Nickel foams were tested in tension, healed then tested again. The change in mechanical properties after healing relative to the original properties is studied by healing samples at different stages of plastic deformation for various durations.

A typical constitutive behavior of a ductile material, such as nickel foam, can be divided into three regimes: the elastic regime (I), and the plastic deformation regime which is composed of the hardening regime (II) and the failure regime (III), as shown in FIG. 3. As such two types of tensile tests were conducted. In the first type, tests were stopped at a strain of 0.020, which corresponds to a point right at the end of regime II when maximum stress is reached and results in microscale cracks, as shown in FIG. 3(a). In the second type, the test is left to continue until the end of regime III when the material loses all its load-carrying capability, resulting in the complete rupture of the sample or large cracks similar to the one shown in FIG. 3(b).

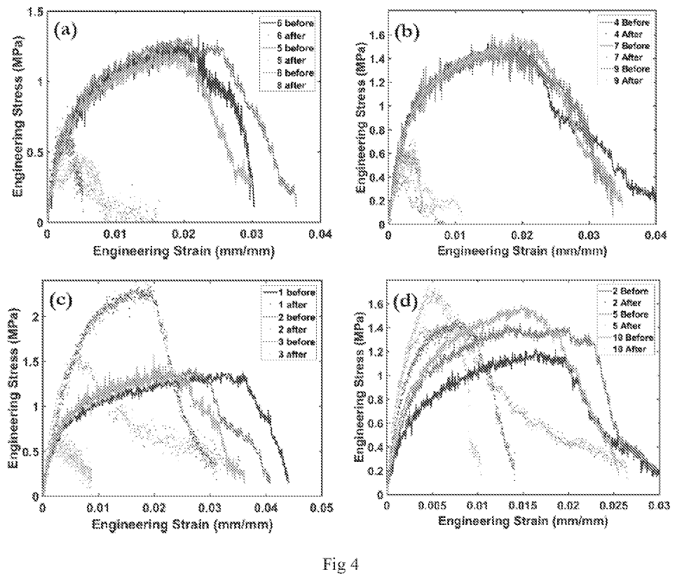

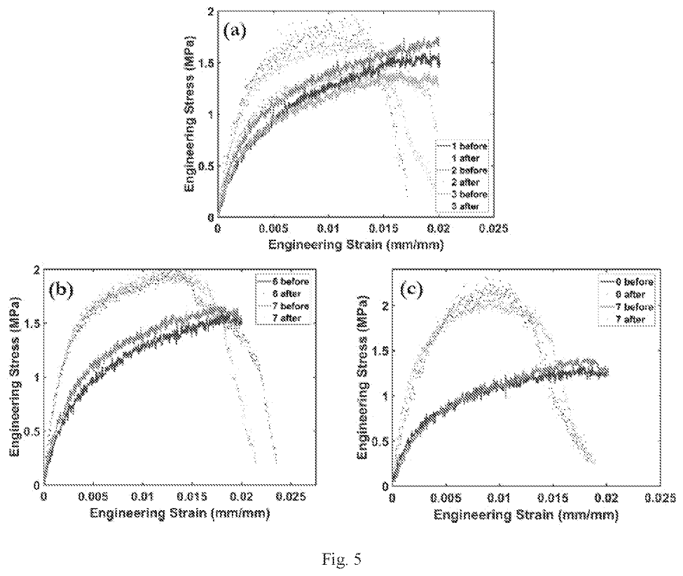

Regime III samples healed for 5 and 3.5 hours are for the most part able to recover their tensile strength, despite a clear decrease in ductility (FIG. 4c, FIG. 4d)). Except for one sample healed for 3.5 hours, the tensile strength of samples healed for 3.5 and 5 hours exceeded their original tensile strength, which (without being bound to any theory) may be due to both the bulking of the foam struts and the nanocrystalline structure of the electrodeposited nickel. Reduced recovery of both tensile strength and toughness is observed in regime III samples healed for 1 hour and 2 hours (FIG. 5c, FIG. 5d), likely (again without being bound to any particular theory) because insufficient amounts of electrodeposited nickel were available to heal all broken struts.

Regime II samples exhibited a markedly different post-healing mechanical behavior as the healing duration had little effect on the tensile strength of the healed samples. FIG. 5 shows the tensile strength of most healed samples exceeded their original tensile strength by 20 to 70 percent, and the difference was more pronounced for samples healed for 5 hours (FIG. 5(d)). The ductility of regime II samples degraded after healing, but not as significantly as the ductility of regime III samples.

Healing Efficiency

To quantify the recoverability of tensile strength and toughness, one can create two parameters: the stress healing efficiency, e_{σ}, which characterizes the tensile strength recovery, and the toughness healing efficiency, e_{T}, which characterizes the toughness recovery. One can calculate e_{σ} and e_{T} using

$$\begin{matrix}{e}_{σ} = \frac{{σ}_{TS , h}}{{σ}_{TS , o}} and & ( 8 ) \\ {e}_{T} = \frac{{W}_{ɛ , h}}{{W}_{ɛ , o}} . & ( 9 )\end{matrix}$$

Where W is the strain energy,

Wₑ=∫σdε. (10)

For healed regime II samples, strain energy was calculated between zero strain and the strain at maximum stress. This approximation equates the calculated strain energy for the second and first tensile tests, as the first tensile test was stopped at or very close to the point of maximum stress. Healed samples have a subscript h and original samples have a subscript o.

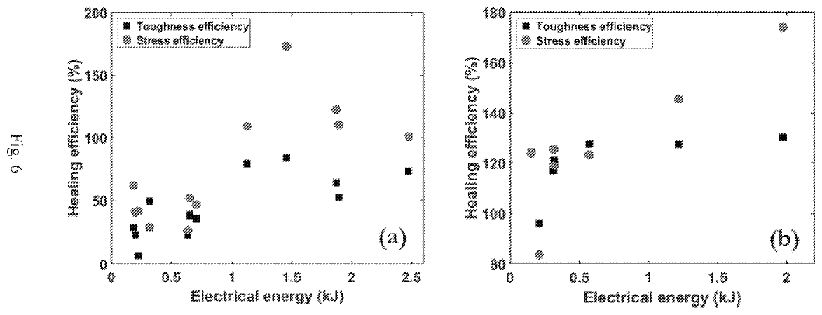

FIG. 6(a) shows that regime III samples exhibited an increase in both measures of efficiency as the amount of energy dispensed during healing increased. A cut-off point between low and high efficiency appears to occur around 1 kJ, as the stress efficiency increases beyond 100% after this point while the toughness efficiency also increases but never exceeds 100%. The maximum stress efficiency, at 173%, is associated with a sample healed for 3.5 h. FIG. 6(b) shows that the toughness and stress healing efficiencies of regime II samples followed different trends. The toughness efficiency increased rapidly until about 0.5 kJ then reached a steady state at around 130%. On the other hand, the stress efficiency increased at two distinct rates: a rapid rate until about 0.5 kJ followed by a slower rate. The maximum stress efficiency reached 174%.

The behavior of both measures of efficiency can be ascribed to both the bulking of the foam's struts due to excess electrodeposited nickel, and the higher strength of electrodeposited nickel compared to the nickel originally available in the foam due to its nanocrystalline structure (explained in the next section).

Effect of Morphology on Mechanical Behavior

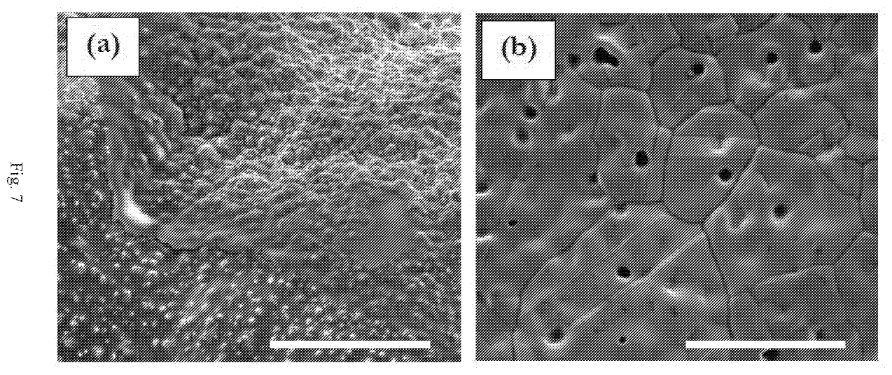

Pristine nickel foam and electrodeposited nickel show different microstructure and surface characteristics, as evidenced by FIG. 7. Electrodeposited nickel shows crystalline grains of nanoscale dimensions, while nickel foam possesses grains that range from a few micrometers to 20 μm in size. A grain size between 10 and 20 nm has been reported to maximize strength in metals as the microscopic deformation mechanism shifts from dislocation-mediated plasticity in a coarse-grained material to grain-boundary sliding in a nanocrystalline material. A study on nanocrystalline nickel fabricated by electrodeposition shows that its yield strength increases linearly with respect to the inverse square root of grain size, in good agreement with the Hall-Petch model. Therefore, and without being bound to any particular theory, electrodeposited nickel likely possesses greater strength than the coarse-grained nickel foam. This fact, combined with the increased density of the foams due to strut bulking from excessive nickel deposition, may explain the higher tensile strengths measure after healing, and, thus, the high stress healing efficiencies which exceeded 100% in many cases. The nanocrystalline structure of electrodeposited nickel can also explain the limited toughness efficiency, as nanostructured metals are known to exhibit low toughness due to a lack of work hardening. Further characterization using x-ray diffraction, electron backscatter diffraction and transmission electron microscopy is needed to improve our understanding of the relationship between the morphology of electrodeposited nickel and the mechanics of healed samples.

Passivation Coating

To understand the role of the passivation layer on the healing process, the electrochemical behavior of ALD alumina was studied. Using a passivating coating with a maximum strain equivalent to nickel can help remediate this issue. It should be understood that the use of alumina in this example is non-limiting, as a passivating coating can be polymeric, ceramic, or of other nature. Parylene-D is one exemplary such coating.

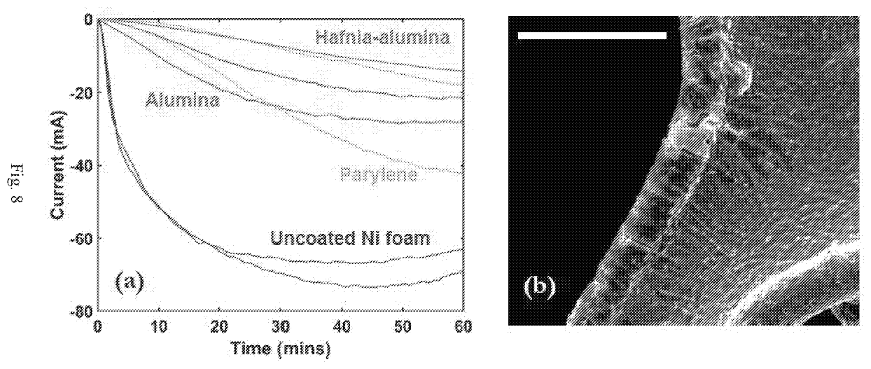

Other insulating conformal coatings on nickel foam samples (100 nm of hafnia on 10 nm of alumina, 150 nm of parylene), performed slightly better than the alumina coatings in a test consisting of nickel electrodeposition on a 1.5×1.5 cm² sample area for one hour at a constant −1.8 V vs. a reference nickel plate. FIG. 8(a) shows that coating nickel foam with any of three coating compositions significantly limited the measured current.

Computational Study

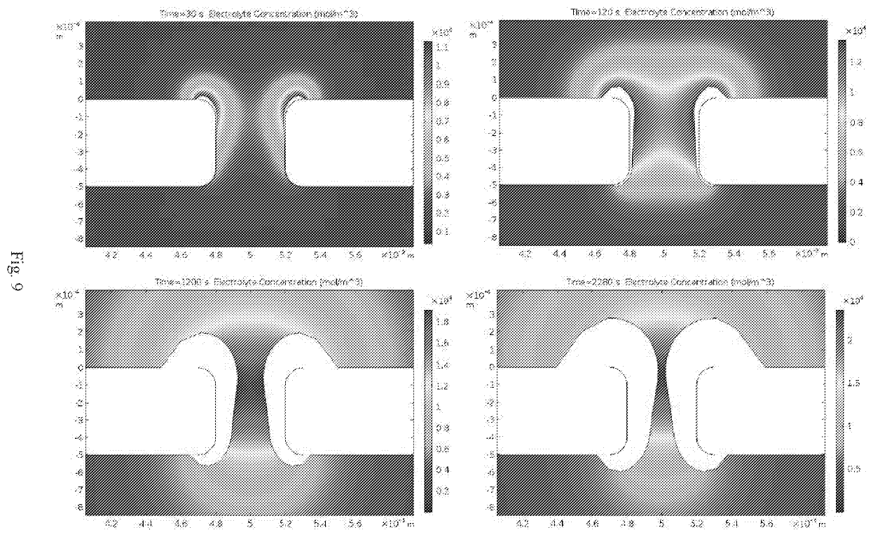

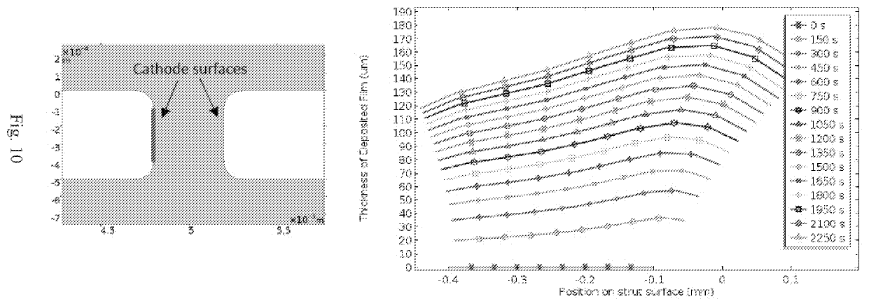

A simulation of nickel electrodeposition was conducted to heal a broken nickel strut in a nickel sulfamate electrolyte at constant voltage. The concentration distribution showed a significant increase in nickel ion concentration close to the cathode (FIG. 9). The concentration was highest around the upper parts of the two cathode surfaces, which resulted in faster nickel growth on the upper parts than on the lower parts. The non-uniformity in nickel growth rate is evidenced by the evolution of the shape of curves representing the surface of the nickel coating on one of the strut's surfaces at different time instants (FIG. 10). Instead of remaining flat, as the curve at t=0, the curve at t=150 s shows a faster growth rate on the upper part of the cathode surface (closer to the anode) than on the lower part. In addition to this local non-uniformity, the increasing proximity of the curves as time passes shows a slowdown in nickel growth rate, as the diffusion of ions becomes more and more restricted as the two nickel films growing from the two cathode surfaces become closer together.

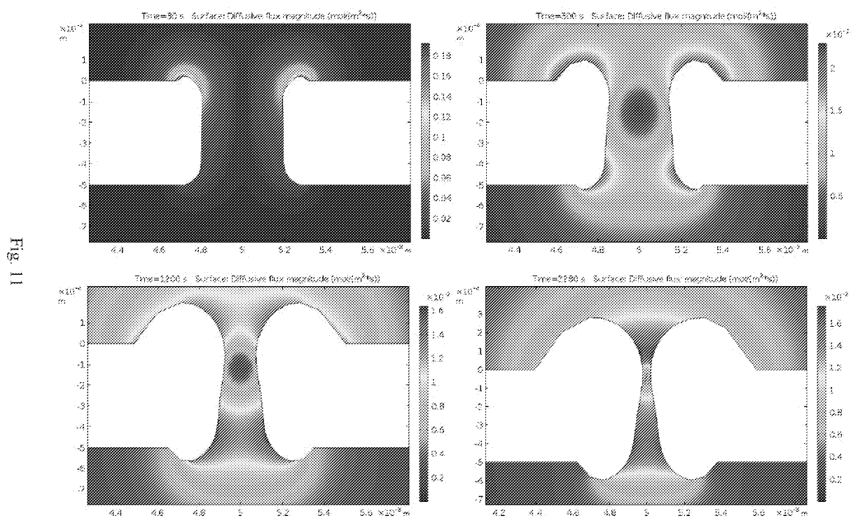

An examination of the diffusive flux elucidates the reason for non-uniformity in nickel coating growth rate. The diffusive flux, as shown in FIG. 11, is initially highest at the upper part of the cathode as nickel ion diffuse and adsorb to the nearest surface with available electrons. But diffusion subsequently dominates, and the diffusive flux becomes highest at the top and bottom of the two cathode surfaces, with a low diffusive flux region located in the middle. Diffusion in this middle region is low likely because the rate at which nickel ions are depleted is much higher than their diffusivity.

The presence of this low diffusive flux region can lead to the formation of a void once the two nickel coatings meet and coalesce to heal the broken strut. Reducing the strut size in the simulation from 500 to 1 μm, which can be achieved empirically by using nanostructured or hierarchical materials, led to a reduction in the time needed for healing but no significant improvement in nickel film uniformity on the strut's surfaces.

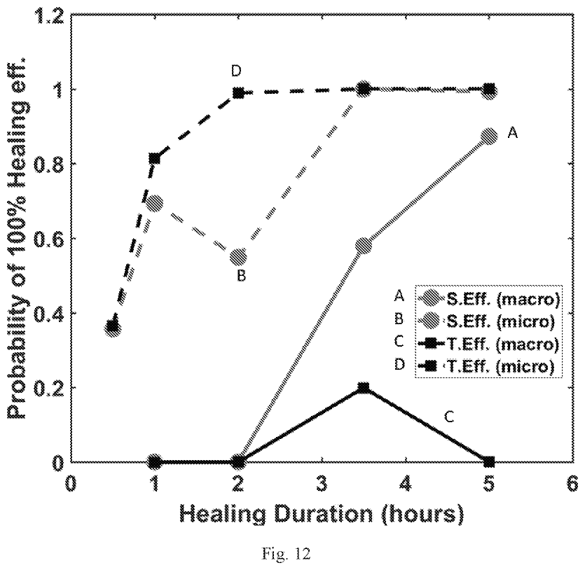

FIG. 12 provides example probability of achieving 100% stress and toughness healing efficiency in healed Ni foams subjected to micro-scale cracking (dashed lines) and large-scale cracking (full lines).

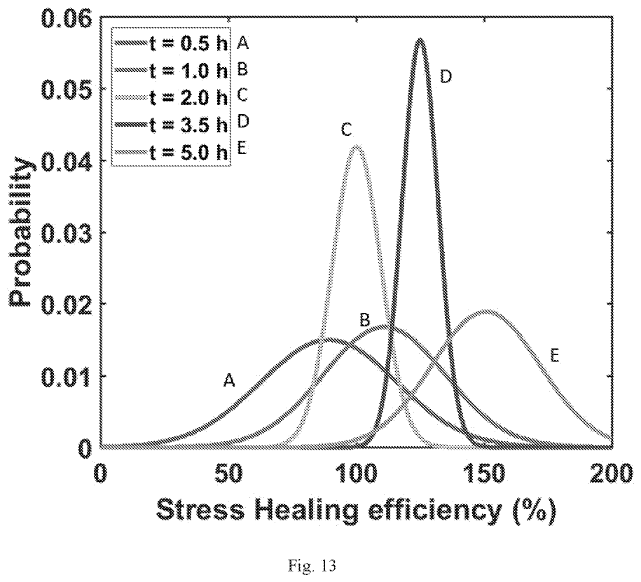

FIG. 13 provides an exemplary Gaussian distribution of stress healing efficiency of Ni foams subjected to micro-scale cracking and healed for varying time durations.

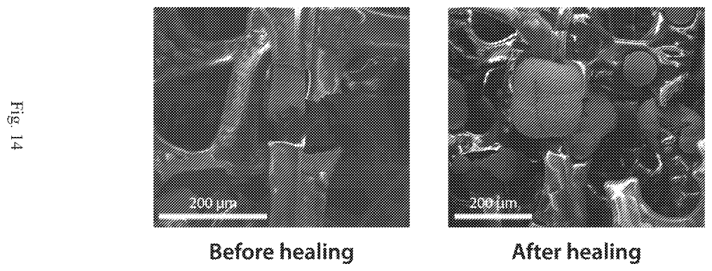

FIG. 14 provides exemplary SEM images showing the same strut in a coated Ni foam before (left panel) and after healing (right panel). The passivating coating limits nickel deposition to cracked areas.

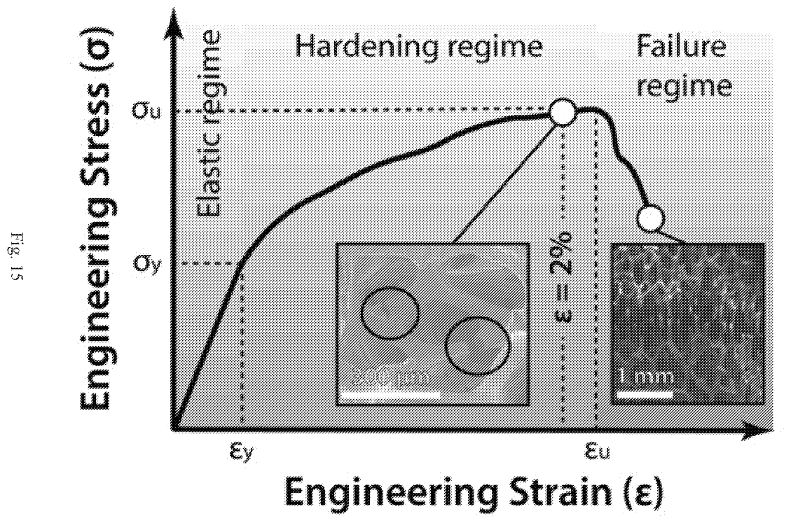

FIG. 15 provides an illustration of Ni foams with two different crack configurations were obtained by halting tensile testing at two distinct regimes

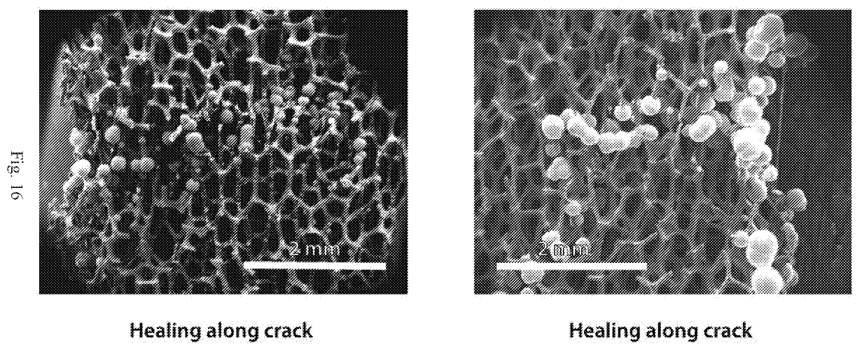

FIG. 16 provides SEM images showing nickel deposits along healed large-scale cracks in Ni foams.

### Additional Disclosure

Although metallic bonds are strong, room-temperature healing of metals is difficult because metal atoms have low room-temperature diffusivities in solid phases (10⁻⁴⁵ to 10⁻³⁵ m²/s). Metals, therefore, are healed at temperatures near or above their melting points which requires high temperatures and large amounts of energy (10⁷ J to 10⁹ J per 1 mm crack length for solute precipitation, for example).

Strategies using low melting temperature alloys (10² to 10³ J/mm), highly-localized joule heating (10² to 10⁴ J/mm), and combined solute diffusion and phase transformation (10⁶ to 10⁷ J/mm) have been developed to reduce the healing energy input, but none have demonstrated effective room-temperature healing.

To achieve effective healing at or near room temperature, biological structural materials, such as bone, transport mass and energy (oxygen, nutrients, and cells, for example) to and from areas where healing is needed. This transport-mediated approach is dramatically different from the local storage of healing matter used by most synthetic healing strategies.

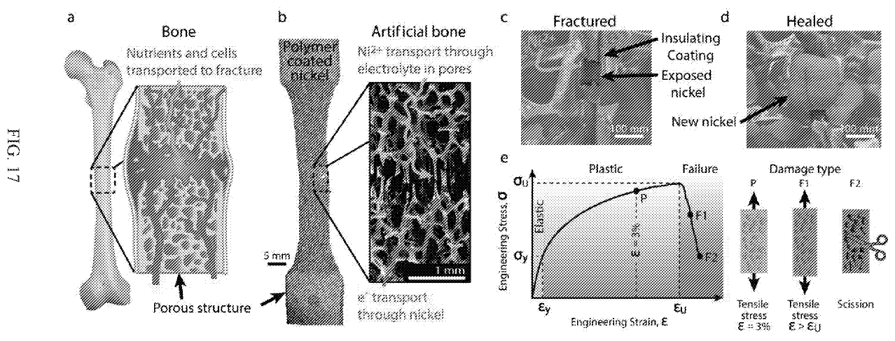

FIG. 17a shows the cellular structure and healing response of bone. The cellular structure plays a critical role in realizing transport-mediated healing. The continuous hard phase (mineralized collagen) provides a structural network to support mechanical loads while the open-cell pores, where open cell means the pore volume is a continuous phase, house functional materials (cells and blood vessels) that sense where fracture occurs and allow mass and energy transport to and from fracture locations. Matter transported to the fracture site forms a cartilaginous callus and reconstructs blood vessels leading to full bone remodeling and healing, which typically takes one month to a few years at 37° C.

In this work, we show electrochemical transport of nickel in polymer-coated cellular nickel materials to demonstrate rapid, effective, and low-energy healing of metal at room temperature. We chose cellular nickel because of its wide use, electrochemical reversibility, and demonstrated light weight and high strength, but it should be understood that nickel is illustrative only and does not limit the scope of the present disclosure.

The polymer coating enabled selective healing only at fractured locations. The combination of ion migration, fast ion diffusion (10⁻⁹ m²/s), and the cellular structure enabled 100% strength recovery of 1.6 mm thick fractured samples after as little as 1500 J and four hours of potentiostatic healing at room temperature. Healed samples fully recovered their strength after being loaded to within 1% strain of total failure, which corresponded to a 350% increase in the fractured nickel strength.

By choosing a polymer coating with a lower failure strain than the underlying metal, plastically-deformed samples were electrochemically strengthened by up to 55% of their original strength, thus preventing fracture in areas exposed to high stress. Also provided is a method to quantify the stochastic healing process and predict healing success based on energy input.

FIG. 17b illustrates an exemplary approach for healing cellular nickel at room temperature. First, we conformally coated 5 to 9 μm-thick films of Parylene D (an insulating polymer with excellent barrier properties and chemical stability) onto cellular nickel. The cellular nickel had 250 μm average diameter pores and 3% relative density. FIG. 17c shows a fractured nickel strut after straining the cellular nickel in tension. The 10% failure strain of Parylene D was large enough so that only severely damaged nickel was exposed, but lower than the 23% failure strain of the nickel so that fractured nickel was not covered by polymer.

Applying a negative potential (−1.8 V) to the fractured cellular nickel, relative to a nickel counter electrode, healed the sample by driving electrons through the conductive nickel to the fracture location and reducing nickel ions in the electrolyte to solid nickel. The open-cell pores enabled rapid ion transport to the fracture site, as previously demonstrated in battery electrodes.

Nickel electrodeposited on both sides of the fractured strut grew until the growth fronts merged, forming a continuous strut (FIG. 17d). The strength of two electrochemically merged interfaces were comparable to bulk nickel. FIG. 17e shows the typical stress-strain data of Parylene-coated cellular nickel. To characterize the healing effectiveness, we healed cellular nickel samples after three types of damage: plastic deformation at 3% strain (P), tensile failure beyond the ultimate strain εᵤ (F1), and local failure by scission (F2) (FIG. 17e).

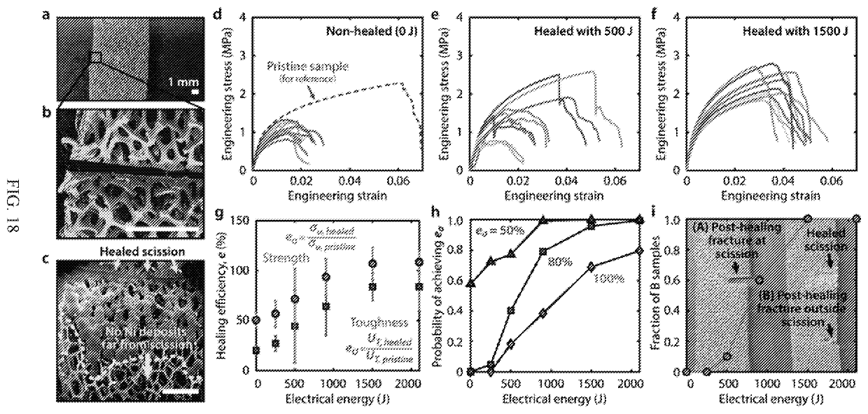

We first characterized the healing of 8 mm-wide dog-bone shaped samples with a 4 mm scission cut at the center (F2 damage). FIG. 18a and FIG. 18b show a photograph and scanning electron microscopy image of cellular nickel after fracture. Damage was limited to the immediate vicinity of the scission. FIG. 18c shows the sample after healing. Nickel electrodeposited on the exposed nickel at the scission merged and formed a dense nickel deposit.

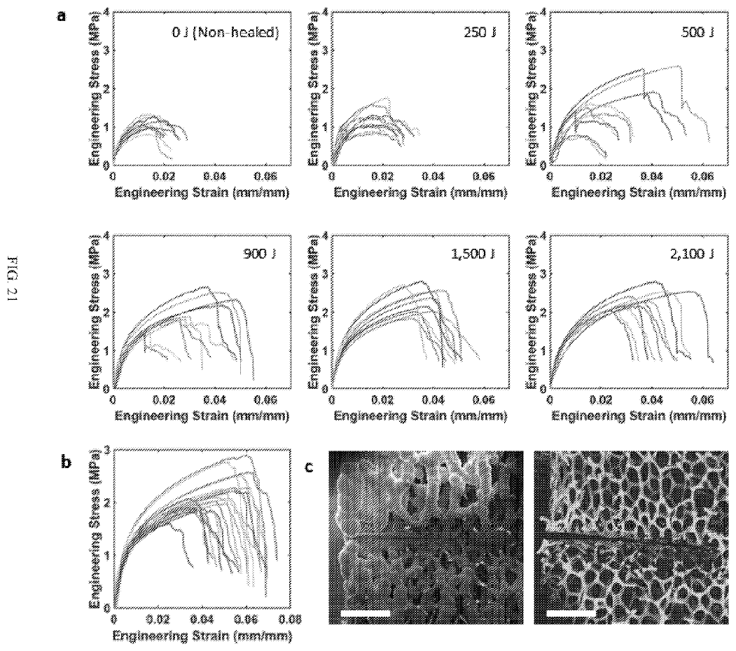

As the scission was applied, stress was imparted on the surrounding cellular nickel, which fractured local segments of the Parylene coating and allowed spherical nickel deposits to form during electrodeposition. The Parylene coating remained pristine and prevented nickel deposition beyond 1 to 3 mm from the scission (FIG. 18c). After healing, we subjected samples to tensile loading until failure. FIG. 18d-FIG. 18f shows the stress-strain behavior of F2 samples healed with 0 J (non-healed), 500 J, and 1,500 J of electrical energy (additional data can be found in FIG. 21). Pristine sample data is shown in FIG. 18d for reference.

The tensile strength σ_{U} (maximum stress) and toughness U_{T} (area under the stress-strain curve) increased with increasing electrical energy input. The tensile strength and toughness were measured from the average of ten healed samples at each energy and normalized by the average strength and toughness of twenty pristine samples to quantify the strength healing efficiency, e_{σ}=σ_{u,healed}/σ_{u,pristine}, and the toughness healing efficiency, e_{U}=U_{T,healed}/U_{T,pristine}. FIG. 18d shows e_{σ} and e_{U} versus energy input.

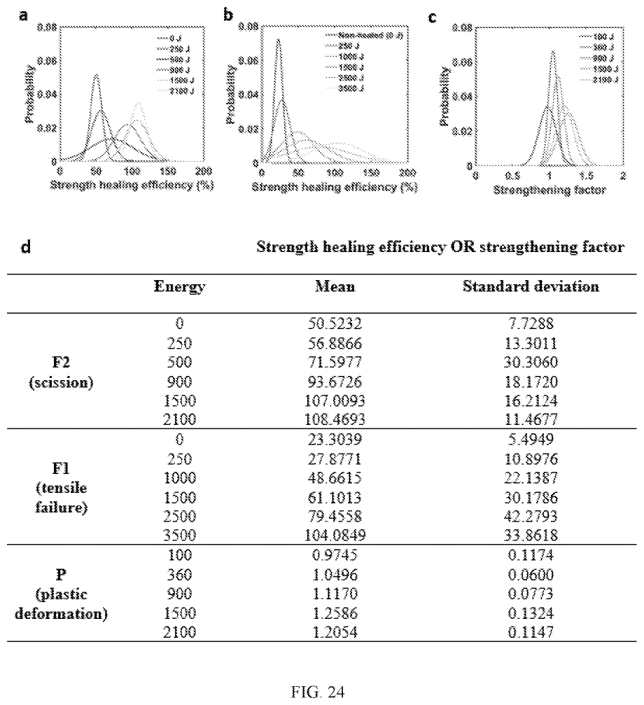

Strength and toughness healing efficiencies increased linearly with energy input from 51% and 20% at 0 J until they plateaued near 100% and 84% at 1,500 J which corresponds to a minimum of four hours of healing. The strength healing efficiency fit normal Gaussian distributions for samples healed at each energy (FIG. 24a). We used the statistical healing efficiency data to predict the likelihood that healed cellular nickel samples achieved a target strength healing efficiency for a given energy input.

FIG. 18h shows the resulting healing curves for 50, 80, and 100% target healing efficiencies. For a sample healed at 1,500 J, there is a 100, 96, and 69% chance of achieving 50, 80, and 100% strength healing efficiencies. Samples loaded after healing fractured either at the healed scission (A samples) or in the cellular nickel outside the scission (B samples). FIG. 18i shows how the fraction of B samples increased with healing energy. This trend suggests that the stagnation of strength healing efficiency after 1,500 J in FIG. 18g is due to the strength of the healed region surpassing the material strength, which forced failure in the surrounding cellular nickel.

We also tested the ability of this healing technique to recover electrical conductivity by cutting the samples in half (complete scission) and comparing the electrical resistance in the pristine state and after healing with 1500 J. The pristine resistance was 0.159±0.001Ω and the healed resistance was 0.163±0.032Ω (see Table 6 below). Thus, we are able to recover electrical resistance after complete scission to within 2.5% of the original value. This result indicates that the disclosed electrochemical healing techniques can enable full recovery of electrical conductivity in cellular metals.

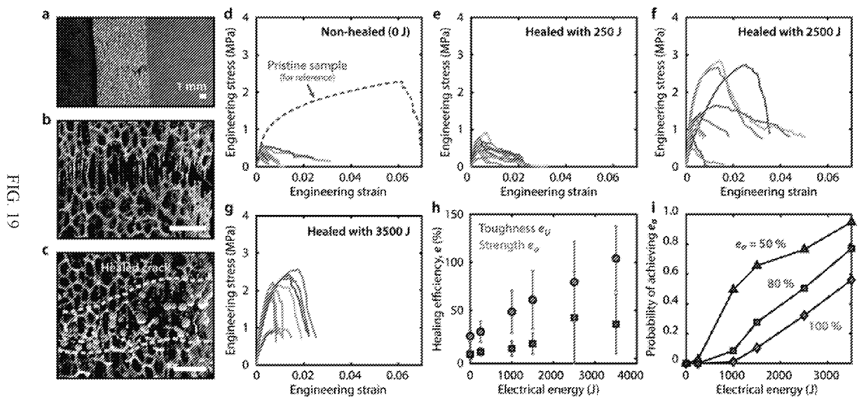

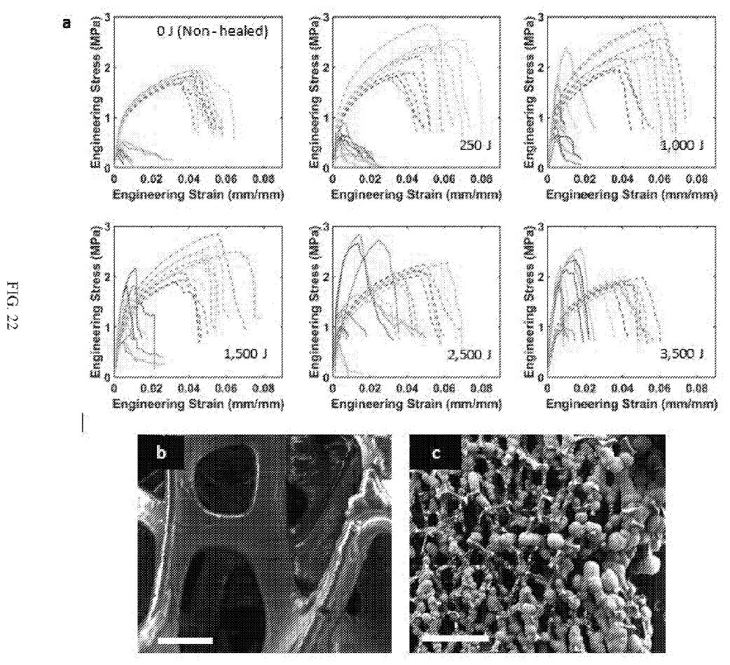

Cellular nickel samples loaded to near failure in tension (F1 damage) exhibited full recovery of strength after as little as 10 hours of healing. FIG. 19a and FIG. 19b show optical and SEM images of cellular nickel subjected to F1 failure. Typically, a single large macroscopic crack (>1 mm) emerged along with numerous microscale cracks (<100 μm) throughout the sample due to the uniform loading (FIG. 21b and FIG. 21c). FIG. 19d-FIG. 19g show stress-strain data of F1 samples strained in tension after 0, 250, 2,500, and 3,500 J of healing (additional data in FIG. 22).

In general, the cellular nickel strength and toughness increased as the input energy increased. The strength and toughness healing efficiencies were the strength and toughness of each healed sample normalized by the same sample's strength and toughness during the first loading. FIG. 19h shows the average strength and toughness healing efficiency of ten samples for each energy.

The average strength healing efficiency increased linearly, starting at 23% for non-healed samples and rising to 104% for 3,500 J, representing a 4.5× increase in the fractured sample strength. The average toughness healing efficiency increased from 4.5% for non-healed samples to 36% after 3,500 J.

We fit healing efficiency data to Gaussian distributions (FIG. 24b), using the same method used for F2 samples, to predict the likelihood that healed F1 samples achieved a target healing efficiency for a given energy input. FIG. 19i shows the healing design curves for 50, 80, and 100% target strength healing efficiencies. The probability of achieving a strength healing efficiency of 50, 80 and 100% is 95, 77, and 56% respectively for a 3,500 J energy input. The high strength healing efficiency was due to the electrodeposited nickel mending cracks and increasing the relative density of the cellular nickel. Without being bound to any particular theory, the limited toughness recovery was likely due to the low ductility of electrodeposited nickel (27 nm average grain size) compared to the pristine cellular nickel with 5-15 μm wide grains (see Experimental Section for an extended discussion). Without being bound to any particular theory, the slight decline in toughness healing efficiency from 42% at 2500 J to 36% at 3500 J (FIG. 19h) is likely due to the brittle nature of the nanocrystalline electrodeposited nickel, compared to the pristine nickel, as well as the electrodeposited nickel locally restricting the bending of nickel struts, which decreased the failure strain.

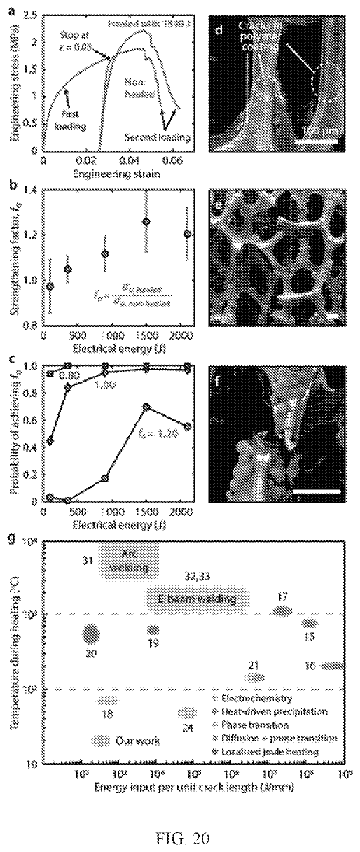

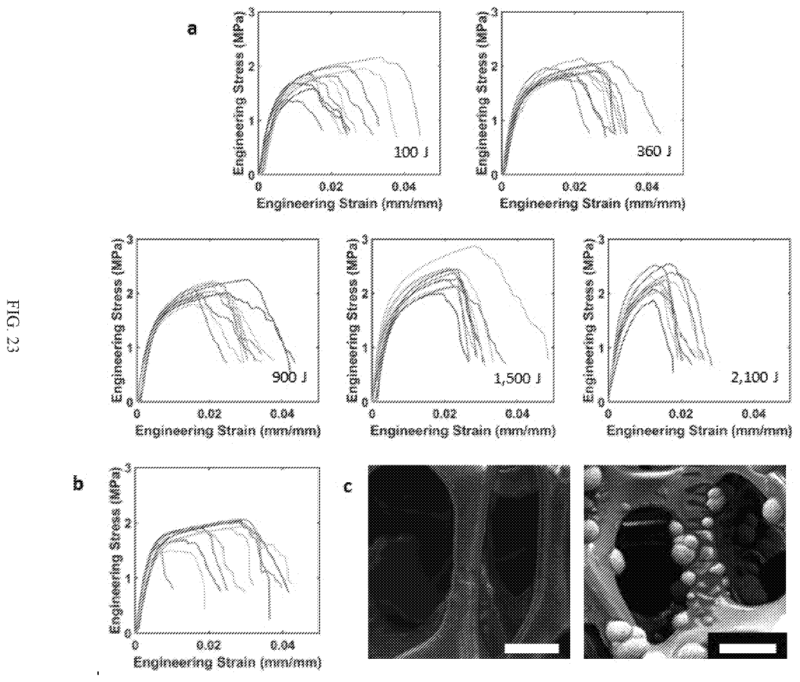

Electrochemical healing of plastically deformed cellular nickel increased the cellular nickel strength and resistance to future failure. To characterize this strengthening effect, we loaded cellular nickel samples in tension until 3% strain (P damage), unloaded the samples, healed them with 0-2,100 J, and then loaded the samples again until failure. FIG. 20a shows the resulting stress-strain data of a healed (pink) and non-healed (blue) sample (additional data in FIG. 23). The tensile strength of the healed sample was noticeably larger than the non-healed sample.

We defined the strengthening factor, f_{σ}, as the ratio of the healed to non-healed strength. Under this definition, f_{σ}=1 for non-healed samples. The strengthening factor represents the extent to which a healed P sample can resist future damage compared to a non-healed sample.

FIG. 20b shows the strengthening factor of cellular nickel samples subjected to 100-2,100 J of healing energy. The average strengthening factor increased from 0.98 to 1.26 until 1,500 J, after which it plateaus. FIG. 20c shows the probability of achieving 0.8, 1.0, and 1.2 strengthening factors with increased energy input. Scanning electron microscopy images provided insight into the strengthening mechanism.

During plastic deformation, local regions of the cellular nickel were subjected to large stress concentrations which cracked the Parylene coating and exposed the underlying nickel when the local strain exceeded the Parylene failure strain (FIG. 20d). Nickel was then electrodeposited on exposed nickel during healing (FIG. 20e), which selectively strengthened the nickel in areas subjected to the highest stress concentrations. Fracture in healed struts during the second loading occurred between nickel deposits (FIG. 200, which confirms that the deposited nickel increased the strut strength.

Transport-mediated electrochemical healing of cellular nickel at room temperature requires lower energy input than many metal healing techniques. FIG. 20g compares the healing temperature and energy input per mm of crack length for several metal healing techniques. Electrochemical healing of cellular nickel required 200 to 700 J/mm at room temperature, about 0.6 to 2.2% of the energy available in a 5,000 mAh smartphone battery. This energy input is 10⁴ to 10⁶ times lower than solute precipitation, 0-10⁴ times lower than electron beam welding, 10² times lower than prior electrochemical healing, 1-10 times lower than arc welding, and comparable to crack-localized joule heating and phase transition in low melting temperature alloys. The low energy requirements of the disclosed healing approach can be especially advantageous to energy-constrained systems, e.g., as autonomous vehicles and battery-powered robots.

The disclosed technology also comprises autonomous healing of fractures in metal. Cracking can be detected using several methods.

In one method, one can apply a short pulse at a negative potential and measuring current. If the current exceeds a threshold value, healing is initiated.

In another method, one can perform a cyclic voltammetry scan and measure the maximum current.

In other methods, one can measure resistance between the metal to be healed and the counter electrode, using a multimeter or electrochemical impedance spectroscopy. When a crack forms, the resistance drops below a threshold value, and healing can be initiated.

In other approaches, when the metal to be healed is different from the metal that is electrodeposited, we can use the difference between their equilibrium redox potentials to initiate healing. In other words, when a crack occurs, the equilibrium potential difference leads to an increase in current, which can be used as a signal to initiate healing by applying a higher current or potential.

Additionally, one can use a strain sensor (capacitive, resistive or piezoelectric) to measure local strain/stress, and initiating healing once a predesignated high strain/stress is reached.

This work demonstrates rapid, effective, and low-energy healing of polymer-coated cellular nickel at room temperature using electrochemistry. Immersing the cellular nickel into an external electrolyte allowed nickel transport from an anode to fractured nickel struts. The polymer coating reduced the required healing energy by restricting nickel plating to only fractured locations.

As described herein, we also provide repeated healing and encapsulating electrolyte into the cellular material for a fully integrated and healable structural material. The disclosed transport-mediated approach can be applied to increase lifetime, reduce weight, and prevent premature failure of cellular metals, which are widely used in structural materials with high strength, high stiffness, and low weight. Additionally, this work presents a new approach to heal electrically and thermally conductive materials.

Additional disclosure is provided below, with reference to certain appended figures.

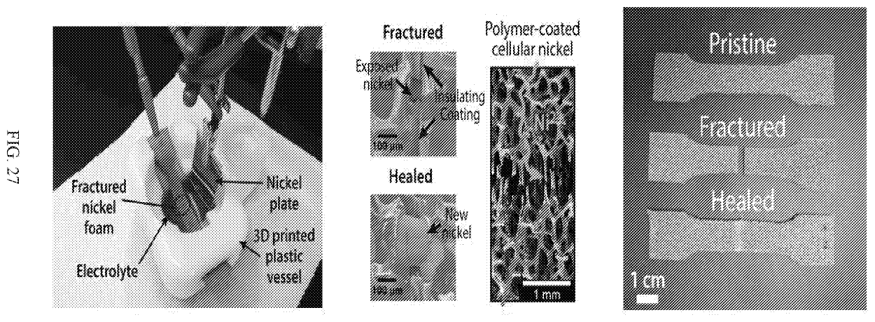

FIG. 27 provides exemplary images of embodiments of the disclosed technology, showing (from left to right) an example setup for healing fractured nickel foam, views of fractured and healed nickel foam, and pristine, fractured, and healed dog-bones of nickel foam.

As shown in the left-hand panel, nickel foam (e.g., fractured nickel foam) is placed in an electrolyte, along with a source of nickel (e.g., nickel plate). A potential is then applied to effect nickel deposition onto the metal foam. The middle panel shows a fractured metal foam, with nickel being exposed through a fracture in an insulating coating disposed on the nickel foam. Following deposition of nickel onto the fracture, the metal foam is healed. The right-hand image shows a dog-bone of nickel in pristine, fractured, and healed (post fracture) conditions.

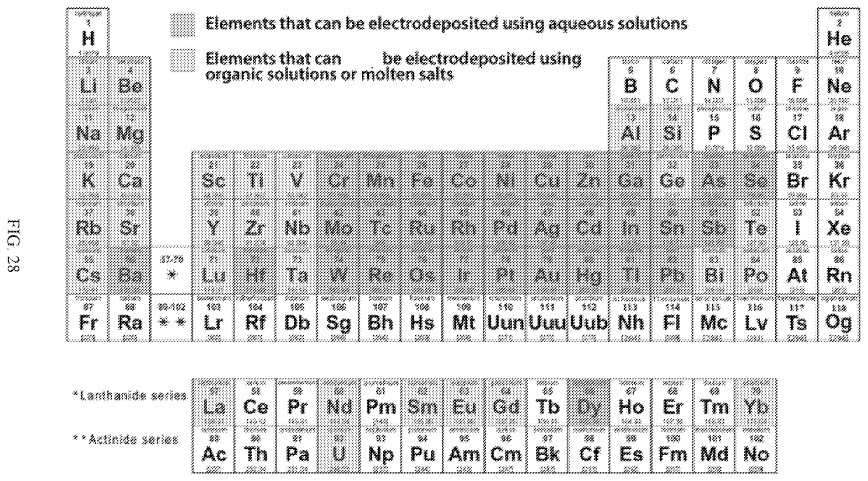

FIG. 28 provides exemplary elements (metals and metalloids) that can be electrodeposited with current technology. Alloys containing two or more of these elements can be electrodeposited as well.

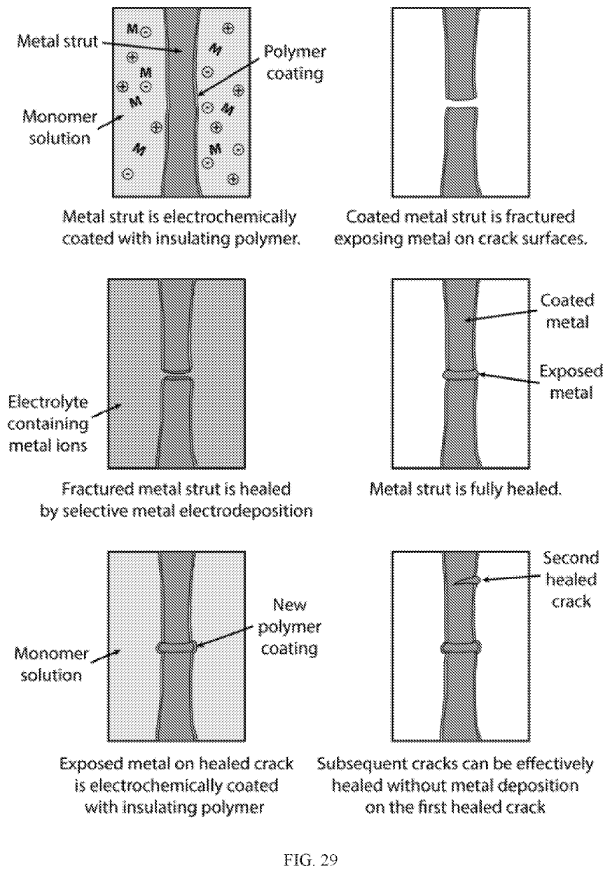

FIG. 29 provides a schematic of an example process according to the present disclosure. As shown, a metal strut (or other metal shape) can be electrochemically coated with an insulating polymer; the polymer's monomer can be disposed in an electrolyte. The coated strut is then fractured, the fracture exposing metal where the coating (and underlying metal) are cracked. A metal ion-containing electrolyte is then contacted to the fractured metal strut, and metal electrodeposition is then performed to deposit metal at the fracture, thereby healing the crack. As shown, the deposited metal is thus exposed to the exterior environment, as the deposited metal is not (yet) covered by a polymeric coating. In a further step, the exposed metal on the healed crack is electrochemically coated with an insulating polymer. As shown, subsequent cracks can be healed without metal deposition on the first healed crack.

Thus, to enable repeatable healing, one can extend the healing technique by electrochemically depositing an insulating polymer on exposed metal after the first healing, then after each subsequent healing step. Because the polymer is deposited electrochemically, polymer is deposited only where metal is exposed and no polymer is deposited in areas where insulating polymer is already present. This repeatable healing technique (shown in FIG. 29) can enable healing of the same metallic part several times with no loss of healing efficiency.

Repeatable healing can proceed in a batch-like manner (e.g., fracture, dip in metal electrolyte, dip in polymer electrolyte, repeat). But one can also create a dual-function electrolyte, as there are polymers that can be deposited from an acidic aqueous medium containing metal ions. In this case, a positive potential is applied to initiate polymer formation, while a negative potential is needed for metal deposition.

Polymers can be deposited electrochemically using a solution that contains a monomer, a salt or some suitable organic compound and a solvent or mixture of solvents. As one example, we deposited polyphenol using a solution containing phenol and allylamine both dissolved in a mixture of water, 2-methoxyethanol and methanol. We used nickel as both the working electrode and the counter electrode. Silver/silver chloride was used as a reference electrode.

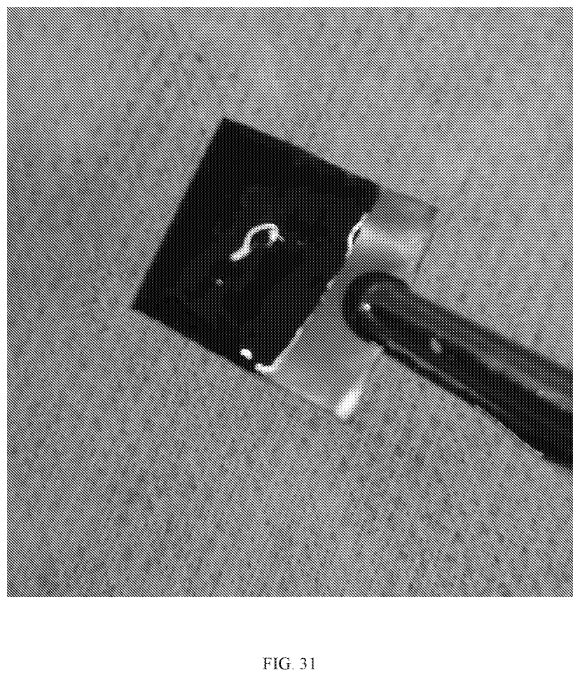

After cycling between 0 and 3V 200 times, we obtained a thick coating on the working electrode as shown in FIG. 31. After drying the polyphenol-coated nickel, we immersed it in a nickel sulfamate electrolyte with a nickel counter electrode, then applied a constant potential of −1.8 V vs. Ni for one hour. The polyphenol coating remained pristine with no signs of nickel growth. One can obtain such barrier properties with other polymers and copolymers.

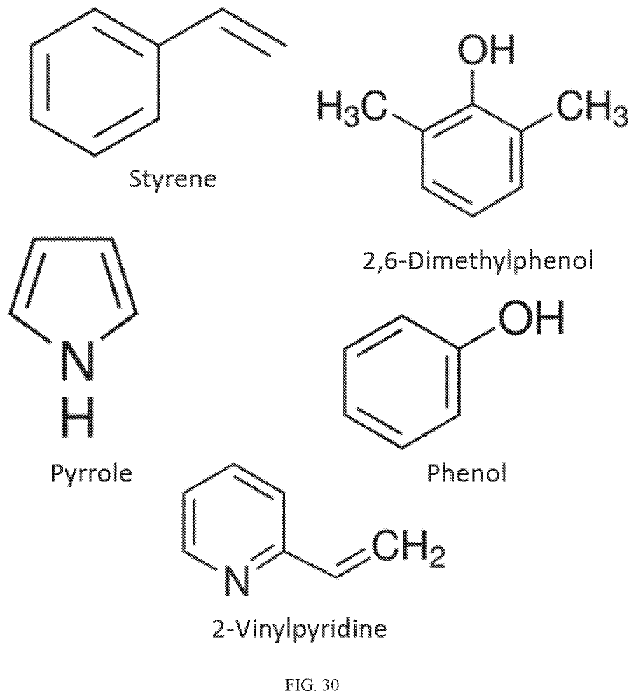

FIG. 30 provides a non-limiting listing of polymers that can be used as insulating polymers for the disclosed technology.

### Additional Experimental Disclosure

Materials: We purchased cellular nickel (nickel foam) with 3% relative density from MTI Corporation, and cut it into dog-bone shaped samples. The samples were 75 mm in length, 15 mm in width and 1.6 mm in thickness, which corresponds to ˜6.4 times the pore size and ˜32 times the strut width. The gauge section for each sample was approximately 45 mm in length and 8 mm in width. Immersing samples for one to two hours in a mixture of methanol (˜93 vol %), hydrochloric acid (˜0.5 vol %), nitric acid (˜0.5 vol %) and ultrapure water (˜6 vol %) removed organic contaminants and etched the native nickel oxide.

A Specialty Coating Systems PDS2010, then, conformally coated samples with Parylene D (poly(dichloro-p-xylylene)) by vapor deposition. We set the dimer vaporizer at 175° C., the pyrolysis furnace at 700° C., and the deposition chamber was kept at room temperature (˜25° C.). Detailed information on the deposition process of Parylene D and its polymerization is available in other articles. We chose Parylene D as a passivating coating because of its chemical stability, high dielectric strength, and superior barrier properties, as well as its failure strain (10%).

To measure the thickness of the Parylene coating, we cleaned ˜2 cm² glass slides by oxygen plasma (100 W and 80 sccm) for 15 mins in an Anatech SCE 106 plasma system, then placed them in the coating chamber with the cellular nickel samples. Parylene thickness ranged from 5 to 9 μm, as determined from step height measurements using a KLA Tencor P7 stylus profilometer.

Mechanical testing: We conducted tensile testing using an Instron 5564 equipped with a 100 N load cell. We set the testing speed at 2.54 mm/min which corresponds to a strain rate of about 0.001 s⁻¹.

Electrical measurements: We performed electrical resistance measurements using a Keithley DMM6500 digital multimeter.

Materials characterization: We performed scanning electron microscopy (SEM) under high-vacuum mode in a FEI Quanta 600 Environmental SEM. Using a Rigaku D/Max-B x-ray diffractometer with a Cu K-α source, we performed x-ray diffraction, then plotted and analyzed the resulting data using X'Pert Highscore Plus by Malvern Panalytical.

Electrochemical healing: We healed cellular nickel, ten samples at each energy, using an electrochemical cell with the sample as the working electrode and a pure nickel plate as the counter/reference electrode.

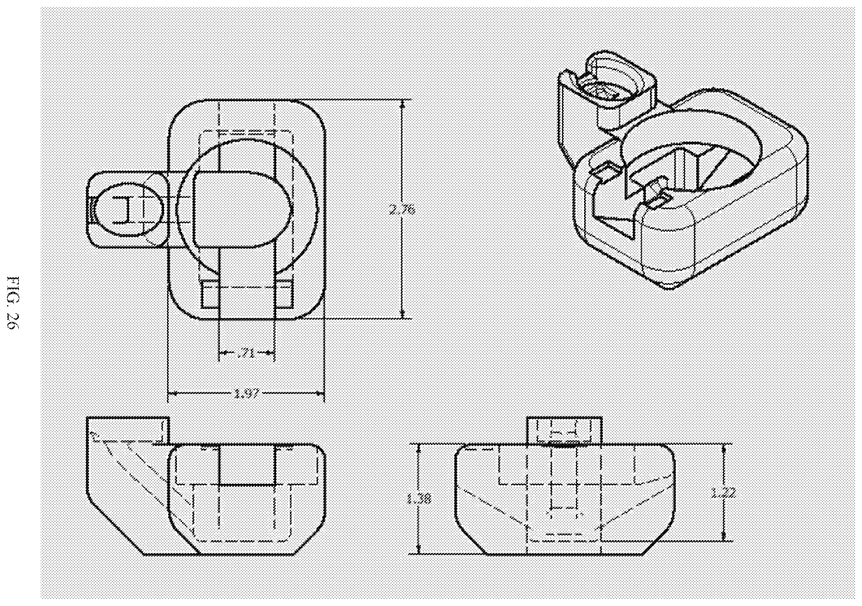

The non-limiting liquid electrolyte was nickel sulfamate RTU (Technic Inc.), which is composed mainly of nickel sulfamate (26%), nickel bromide (0.7%) and boric acid (2.3%). Immersing the samples briefly in isopropyl alcohol or methanol immediately before healing improved electrolyte wetting. A 3D printed device served both as electrolyte vessel and sample holder during the electrochemical healing process (FIG. 26). The healing of all samples was conducted at room temperature, 21.1±0.3° C.

A BioLogic SP-300 potentiostat/galvanostat controlled the electrochemical cell, supplying a constant voltage (−1.8 V vs. Ni), measuring the current i(t), and stopping when the target total charge output Q was reached. We obtained energy E by multiplying the total charge Q by the voltage V as follows,

E=V·Q=V∫i(t)dt. (1)

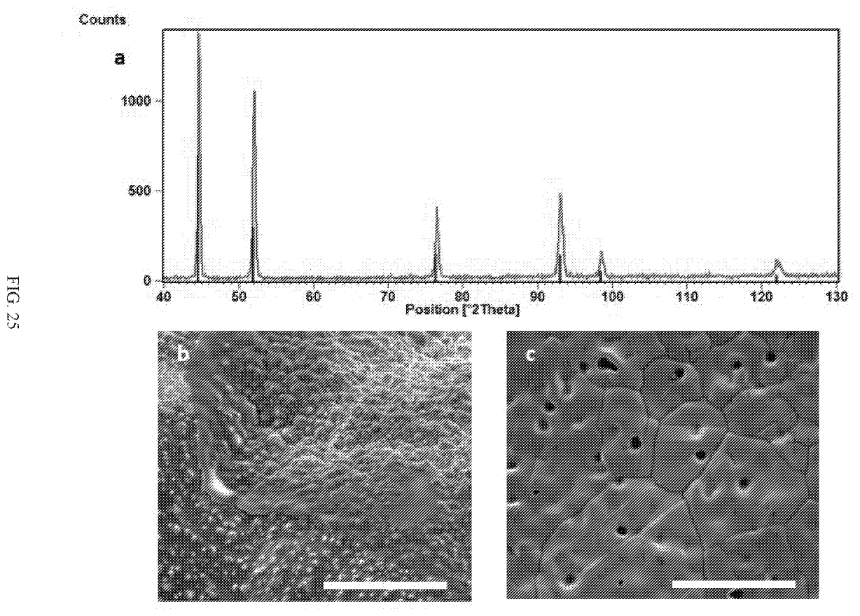

Scherrer analysis of XRD data: We performed x-ray diffraction on a thick layer of electrodeposited nickel coated on the same cellular nickel used in this work (FIG. 25a). The electrodeposition occurred in the same conditions described above (−1.8 V vs. Ni reference, Ni sulfamate RTU electrolyte, and room temperature). We used the Scherrer equation to estimate grain size,

$$D = \frac{K λ}{β cos θ} , \qquad ( 2 )$$

where D is the crystalline grain size, K is a dimensionless shape factor (K˜1), λ is the x-ray wavelength (here, λ, =0.154 nm), β is the peak broadening (defined as the peak width at half the maximum intensity), and θ is the Bragg angle. By applying Eq. 2, we obtained an average grain size of 27 nm in electrodeposited nickel. This grain size was qualitatively confirmed by SEM (FIG. 25b). In comparison, the pristine cellular nickel had grains ranging in size from 5 to 15 μm (FIG. 25c). Since nickel follows the Hall-Petch model, we concluded that the electrodeposited nickel had higher strength and lower ductility than the pristine nickel.

Probabilistic analysis of healing success: The cellular nickel samples showed a stochastic healing performance (Tables 2-4). In other words, healing with a high energy input did not guarantee a high healing efficiency. Therefore, we developed a probabilistic approach based on Gaussian statistics to analyze and predict the evolution of mechanical properties due to healing.

We calculated the probability of achieving a target strength healing efficiency (for F1 and F2 samples) or strengthening factor (for P samples) for each healing energy. Ten samples were processed, tested and healed as described above for each value of energy input. We then calculated the relevant figure of merit (strength healing efficiency e_{σ}, or strengthening factor f_{σ}) for each sample depending on its damage type (P, F1 or F2). Using Matlab, we produced a Gaussian (normal) probability distribution that fits each set of ten data points for a given energy. The result is a probability density function (pdf) for each set of ten samples (FIG. 24). The probability density function φ(x) of a statistical variable x is described by

$$φ ( x ) = \frac{1}{\sqrt{2 π {v}^{2}}} {e}^{- {( x - μ )}^{2} \text{/} 2 {v}^{2}} , \qquad ( Equation S1 )$$

where ν is the standard deviation and μ is the arithmetic mean. In practical terms, the Matlab fitting process consisted of finding the values of μ and ν for each set of ten samples.

To calculate the probability of x=a, we integrate φ(x) as follows:

p(x=a)=∫ₐ^{∞}φ(x)dx. (Equation S2)

The lower bound of integration was the target figure of merit and the upper bound was set to e=250% (or f_{σ}=2.50). Using this method, we plotted design figures (FIGS. 18h, 19i, and 20b) that enabled the targeting of expected healing performance based on a specific energy input.

Estimation of Healing Energy and Temperature from the Literature:

We resorted to different means to estimate the healing energy and temperature ranges for our work, different metal healing methods, and two metal welding methods (arc welding and electron beam welding).

For arc welding, we obtained a voltage range of 17-45 V and a current range of 190-590 A which encompasses the most common arc welding techniques (gas metal arc welding, flux-cored arc welding, and shielded metal arc welding, for example). The current and voltage ranges yielded a power range of 3,230-26,550 W. The travel speed ranged from 2 to 10 mm/s. Dividing the power by the travel distance in a second provides the energy input per mm crack length: 323 to 13,275 J/mm.

The temperature of the plasma arc at the metal surface was reported to be between 3,000 and 20,000° C. For electron beam welding, the energy input ranges from 6,000 to 3,000,000 J/mm. A study of the temperature distribution on the surfaces of different metals and metallic alloys during electron beam welding revealed that peak temperatures range from 1,100 to 2,300° C.

For the various reports of metal healing, we calculated energy input based on available information such as healing time, temperature, current, and voltage. In cases where information on the furnaces used for heating could not be obtained, we used the electric power of commercial lab furnaces by Thermo Scientific rated for the temperature range in the study to calculate total energy consumption (1,000 W for ˜1,200° C., 700 W for ˜750° C., 190 W for ˜200° C., and 170 W for ˜150° C.). For the electrochemical healing study, we calculated energy input based on 500 ml of electrolyte with the same specific heat capacity as water and determined convective heat losses to be negligible.

Temperature ranges were all reported in their respective studies except for one study on crack-localized joule heating which we assumed to have roughly the same temperature range as the other study that used the same healing method. For each study, the calculated energy was normalized by the healed crack length. Whenever the sizes of healed cracks were not explicitly reported, we relied on scanning electron micrographs to estimate crack size. We summarize the data estimated or directly retrieved from other metal healing reports in Table 5.

For our work, we estimated the lower bound of healing energy per unit crack length based on a F2 sample with a 4 mm scission healed with 900 J. The upper bound was estimated based on a F1 sample with a 5 mm macroscopic crack healed with 3,500 J.

Possible Empirical Explanations for the Variation in Post-Healing Stress-Strain Data:

For identical conditions, many cellular nickel samples exhibited great variation in their stress-strain behavior after healing. Without being bound to any particular theory, this variation may be due to two reasons.

The first reason is the significant variation in relative density resulting from the variation in parylene coating thickness. Since the cellular nickel struts are hollow with ˜10 μm-thick walls, the volume fraction of the Parylene coating (5 to 9 μm in thickness) varies between 41% and 57%, which is representative of most of the variation in strength that we measure experimentally.

The second reason is that when the foam is fractured, the individual struts that make up the foam are split into two parts and there is a natural variation in the distance between the two parts of a fractured strut. If the spacing between fractured struts is larger, more energy is required to heal those struts. The stochastic distribution of spacings between fractured struts means that samples healed at the same energy can exhibit varying levels of strength and toughness as only a certain fraction of the fractured struts are close enough to heal effectively.

TABLE 2
Strength healing efficiency e_{σ} and toughness
healing efficiency e_{U} for all F2 samples.

| 0 J | | 250 J | | 500 J | |
|---|---|---|---|---|---|
| e_{σ} | e_{U} | e_{σ} | e_{U} | e_{σ} | e_{U} |
| 44.8738 | 15.9935 | 58.2133 | 30.2323 | 89.1772 | 76.1944 |
| 44.6317 | 14.9267 | 74.6148 | 35.5187 | 70.1961 | 38.4706 |
| 38.0732 | 14.6607 | 81.7306 | 41.2253 | 75.1629 | 43.0954 |
| 46.0657 | 20.4104 | 60.8511 | 32.9445 | 117.0358 | 84.52 |
| 48.1259 | 15.7461 | 57.3192 | 25.7382 | 120.5706 | 116.732 |
| 58.6377 | 21.296 | 56.8274 | 19.6087 | 34.6966 | 12.0655 |
| 59.2263 | 26.1214 | 48.6316 | 22.4507 | 66.3764 | 28.345 |
| 53.2709 | 27.6469 | 39.9978 | 19.3036 | 36.4651 | 14.0729 |
| 49.9348 | 16.0855 | 48.7349 | 24.7125 | 43.7843 | 2.8569 |
| 62.3922 | 27.4423 | 41.9449 | 19.2681 | 62.5122 | 27.0546 |

| 900 J | | 1,500 J | | 2,100 J | |
|---|---|---|---|---|---|
| e_{σ} | e_{U} | e_{σ} | e_{U} | e_{σ} | e_{U} |
| 108.1753 | 97.0712 | 93.9784 | 65.8805 | 95.2939 | 52.0583 |
| 83.1004 | 52.4603 | 85.4738 | 64.2525 | 100.6287 | 74.5683 |
| 85.1732 | 63.8496 | 90.5907 | 71.394 | 94.8645 | 56.0464 |
| 123.7154 | 93.5784 | 99.9121 | 83.3149 | 104.2474 | 66.5609 |
| 117.2572 | 100.7517 | 94.0625 | 91.2723 | 106.4991 | 88.7265 |
| 87.8115 | 52.5474 | 118.3926 | 96.0715 | 102.6186 | 68.7005 |
| 101.7359 | 87.7235 | 130.5875 | 95.8774 | 130.0777 | 113.407 |
| 70.1591 | 22.1144 | 110.7877 | 90.2446 | 118.627 | 124.8568 |
| 86.1892 | 42.06 | 119.7367 | 103.4487 | 112.2841 | 89.2017 |
| 73.4091 | 29.0506 | 126.5708 | 76.4666 | 119.5524 | 105.4429 |

TABLE 3
Strength healing efficiency e_{σ} and toughness
healing efficiency e_{U} for all F1 samples.

| | | |
|---|---|---|
| 0 J | 250 J | 1,000 J |

| e_{σ} | e_{U} | e_{σ} | e_{U} | e_{σ} | e_{U} |
|---|---|---|---|---|---|
| 21.0943 | 2.9985 | 35.0746 | 14.3804 | 33.0123 | 13.6124 |
| 23.6453 | 3.5352 | 35.1792 | 8.4700 | 64.5745 | 9.9222 |
| 16.7393 | 1.5321 | 25.3237 | 8.5484 | 36.2600 | 5.5118 |
| 19.0665 | 1.5606 | 40.7039 | 10.2332 | 25.6704 | 2.9258 |
| 27.7569 | 13.1454 | 40.1619 | 5.1628 | 58.0123 | 6.3404 |
| 15.0923 | 1.1752 | 36.8715 | 8.5879 | 24.4865 | 5.1419 |
| 30.1459 | 11.4526 | 16.5049 | 5.8940 | 41.5218 | 8.2369 |
| 24.6799 | 3.9063 | 12.4887 | 3.5789 | 94.6802 | 29.9663 |
| 23.1653 | 2.5836 | 20.3087 | 3.1602 | 41.3786 | 7.4766 |
| 31.6532 | 3.2104 | 16.1541 | 1.4037 | 67.0186 | 14.7414 |

| 1,500 J | | 2,500 J | | 3,500 J | |
|---|---|---|---|---|---|
| e_{σ} | e_{U} | e_{σ} | e_{U} | e_{σ} | e_{U} |
| 95.6751 | 18.8274 | 48.9879 | 6.8230 | 130.2697 | 69.7569 |
| 111.9315 | 31.5815 | 131.4432 | 64.6084 | 114.4421 | 39.9882 |
| 87.9601 | 34.1084 | 59.9733 | 16.9451 | 91.7985 | 12.2286 |
| 29.4396 | 10.0856 | 131.5648 | 100.7711 | 49.7342 | 10.8695 |
| 30.6392 | 5.8910 | 66.7634 | 9.3828 | 51.4856 | 14.9047 |
| 41.6183 | 5.9003 | 135.1484 | 82.1517 | 97.0847 | 17.8115 |
| 28.7275 | 10.1522 | 35.9451 | 3.2211 | 130.4396 | 48.8561 |
| 46.8527 | 6.8506 | 101.6827 | 130.5233 | 116.8388 | 16.7466 |
| 67.1198 | 6.9835 | 61.9500 | 8.0510 | 156.4824 | 104.1017 |
| 71.0493 | 23.5992 | 21.0992 | 3.0180 | 102.2734 | 21.8186 |

TABLE 4
Strengthening factor f_{σ} values for all P samples.

| 100 J | 360 J | 900 J | 1,500 J | 2,100 J |
|---|---|---|---|---|
| 1.0751 | 1.0885 | 1.1195 | 1.2201 | 1.3691 |
| 0.9796 | 1.0578 | 1.1821 | 1.2739 | 1.2821 |
| 1.0515 | 1.0618 | 1.1826 | 1.3213 | 1.2098 |
| 0.8546 | 1.0055 | 1.2130 | 1.3158 | 1.1162 |
| 1.1619 | 1.1531 | 1.0669 | 1.3250 | 1.2065 |
| 0.9993 | 0.9988 | 0.9671 | 1.5475 | 1.0942 |
| 0.9111 | 1.0295 | 1.0834 | 1.0736 | 1.0059 |
| 0.7433 | 0.9553 | 1.0614 | 1.1446 | 1.3563 |
| 0.9926 | 1.1235 | 1.0966 | 1.2138 | 1.1696 |
| 0.9763 | 1.0226 | 1.1971 | 1.1504 | 1.2445 |

TABLE 5
Healing energy, temperature and crack length in different studies of metal healing.

| Reference | Healing method | Energy (J) | Temperature (° C.) | Crack length (mm) |
|---|---|---|---|---|
| 15 (K. W. Gao, et | Heat-driven | 2.80E5 | 700 to 750 | 0.002 |
| al. Scr. Mater. | precipitation | | | |
| 2001, 44, 1055.) | | | | |
| 16 (C. Chen, Appl. | Heat-driven | 6.84E7 | 200 | 0.100 |
| Phys. Lett. 2016, | precipitation | | | |
| 109, DOI | | | | |
| 10.1063/1.4962333 | | | | |
| 17 (H. Yu, Metall. | Heat-driven | 1.20E6 | 1050 to 1200 | 0.050 |
| Mater. Trans. A | precipitation | | | |
| Phys. Metall. | | | | |
| Mater. Sci. 2014, | | | | |
| 45, 1001) | | | | |
| 18 (I. M. Van | Phase transition | 5.0E3 | 70 | 15.000 |
| Meerbeek, Adv. | | | | |
| Mater. 2016, 28, | | | | |
| 2801) | | | | |
| 19 (H. Song, Sci. | Joule heating | −200 | 600 | 0.020 |
| Rep. 2017, 7, 1) | | | | |
| 20 (A. Hosoi, | Joule heating | −35 | 600 | 0.250 |
| Mater. Sci. Eng. A | | | | |
| 2012, 533, 38) | | | | |
| 21 (J. T. Kim, Sci. | Heat-driven | 2.25E5 | 150 | 0.050 |
| Rep. 2018, 8, 2) | precipitation + | | | |
| | Phase transition | | | |
| 24 (X. G. Zheng, | Electrochemistry | 4.0E4 to 2.0E5 | 40 to 55 | 1.500 |
| Y. N. Shi, K. Lu, | | | | |
| Mater. Sci. Eng. A | | | | |
| 2013, 561, 52) | | | | |

TABLE 6
Electrical resistance for three pristine cellular
nickel samples and the same samples after healing
from complete scission with 1500 J of energy input.

| | Pristine | After healing |
|---|---|---|
| Average (Ω) | 0.159 | 0.163 |
| Standard deviation (Ω) | 0.001 | 0.032 |

### SUMMARY

Using electrodeposition enabled the recovery of tensile strength and toughness in fractured or plastically deformed nickel foams. Regime II samples showed good recovery of mechanical properties with high healing efficiencies regardless of healing time. On the other hand, regime III samples, which had large cracks, depended strongly on healing time in their ability to recover their mechanical properties. Those samples healed for 5 and 3.5 hours exhibited, for the most part, high healing efficiencies, while samples healed for less time showed both low toughness and low tensile strength. The improved mechanical properties of samples after healing was attributed to the bulking of the struts with excess nickel and to the high strength of electrodeposited nickel due to its nanocrystalline structure.

A simulation of nickel electrodeposition to heal a broken foam strut showed that spatial and time-dependent variations in the diffusive flux of nickel ions led to non-uniform deposition. This non-uniformity means that the formation of small voids is possible, albeit at a smaller scale than in bulk metals. Future iterations of this simulation will use the level set method, instead of the deformed mesh method, to analyze the geometry and size of these voids since it allows topological changes. The simulation can, therefore, be continued beyond the point when the nickel films growing from the two strut surfaces meet and form one continuous domain.

### EXEMPLARY EMBODIMENTS

The following embodiments are exemplary only and do not serve the limit the scope of the present disclosure or the attached claims.

Embodiment 1. An adaptive material system, comprising: an electrically conductive matrix material defining a plurality of voids; and an electrolyte disposed in at least some of the voids, the electrolyte comprising at least an ion of a first metal, the electrolyte optionally comprising an amount of a monomer. The system can also optionally include a device configured to detect a fracture within the matrix material. Such devices include, e.g., a current-measuring device, a resistance-measuring device, a device configured o measure equilibrium potentials, a strain sensor, a cyclic voltammeter, or any combination thereof.

Essentially any monomer can be used with the disclosed technology; monomers that include a vinyl group (e.g., a C=C) are considered especially suitable, as are cyclic monomers, e.g., those monomers that include a carbon-containing ring structure, such as styrene. Exemplary vinyl monomers include, e.g., acrylonitrile, acrylic acid, N-methylolacrylamide, methyl methacrylate, styrene, maleic anhydride, methacrylic acid-acrylamide, methacrylic acid-N,N′-methylenebisacrylamide, glycidyl methacrylate, and the like.

B. K. Garg, R. A. V. Raff, R. V. Subramanian, Electropolymerization Of Monomers On Metal Electrodes, J. Appl. Polym. Sci. 22, 65-87 (1978) (incorporated herein by reference in its entirety) provides example monomers and electrolytes/solvents for use in electrodeposition. Such monomers include, without limitation, phenyl glycidyl ether, N-methylolacrylamide, azirdine, and the like.

An electrolyte can include, e.g., water, an organic solvent, an ionic liquid, and the like. Polar and non-polar solvents can be used. Example solvents (that can be used as electrolytes) include, e.g., propylene carbonate, acetonitrile, ethylene carbonate, dimethyl carbonate, THF, DMSO, and methanol. Any of the foregoing can be used as the solvent in which the first metal ion is disposed.

A monomer can be disposed in any of the foregoing. Monomers can be dispersed in water, organic solvent, and the like.

Example metals include, e.g., nickel, zinc, tin, iron, copper, cobalt, tungsten, gold, silver, brass, palladium, cadmium, rhenium, tungsten, lithium, titanium, chromium, platinum, and aluminum. The foregoing list is exemplary only and is not limiting.

Embodiment 2. The system according to Embodiment 1, further comprising a source of electrical current capable of electronic communication with the electrolyte. Exemplary such sources include, e.g., potentiostats, electronic voltage sources, electronic current sources, photovoltaics, flexoelectrics, photoelectrics, batteries, supercapacitors, capacitors, piezoelectrics, thermoelectrics, pyroelectrics, photoelectrics, triboelectrics, photoelectrochemicals, magnetoelectrics, microbial, and thermogalvanic.

As an exemplary embodiment of the thermogalvanic effect, one part of the matrix is brought from equilibrium to a different temperature than another part of the matrix. This temperature difference results in a difference in the Gibbs free energy of the electrochemical reactions between the matrix and electrolyte. The Gibbs free energy difference between the hot and cold areas drives electrochemical oxidation (or reduction depending on the reaction) at the hot location, and vice versa at the cooler locations.

Embodiment 3. The system according to any of Embodiments 1-2, further comprising a region of conformal coating disposed on a coated region of the matrix material, the region of conformal coating being disposed so as to interrupt fluid communication between the coated region of matrix material and the electrolyte. The conformal coating can be non-conductive. The conformal coating can also be non-reactive with the electrolyte and/or with the matrix material. (The conformal coating can also be termed a passivation coating or a passivation layer.)

Embodiment 4. The system according to Embodiment 3, wherein the conformal coating is characterized as a dielectric.

Embodiment 5. The system according to any one of Embodiments 1-4, wherein the matrix material defines an elongation at break of unit length/length (m/m).

Embodiment 6. The system according to Embodiment 5, wherein the conformal coating defines an elongation at break that is within about 5% of the elongation at break of the matrix material.

Embodiment 7. The system according to Embodiment 5, where in the conformal coating is configured such that a mechanical stress that fractures the coated region of matrix material does not fracture the region of conformal coating.

In such embodiments, the matrix material breaks before the coating breaks. This can be used in embodiments where small fractures in the matrix material are acceptable to the user; by the time fractures form in the coating (so as to allow electrolyte contact with the underlying matrix material), relatively large fractures are present in the matrix material.

Embodiment 8. The system according to Embodiment 5, wherein the conformal coating is configured such that a mechanical stress that fractures the coated region of matrix material fractures the region of conformal coating. In such embodiments, the coating and the underlying matrix material break together such that cracks in the matrix material contact the electrolyte at the same time that such cracks are formed, as cracks form in the coating at the same time as cracks in the matrix material.

Embodiment 9. The system according to Embodiment 5, wherein the conformal coating is configured such that a mechanical stress that fractures the region of conformal coating does not fracture the coated region of matrix material. In such embodiments, the coating breaks before the underlying matrix material. In such a way, areas of the matrix material that are likely to fracture are contacted with electrolyte (by way of the already-cracked coating) before those areas fracture, and the electrolyte acts to pre-heal and/or strengthen those regions of the matrix material before fractures form.

Embodiment 10. The system according to any one of Embodiments 3-9, wherein the conformal coating comprises silica, parylene, an acrylic, ceramic/metal oxide (e.g., alumina, hafnia, titania), a polymer (e.g., polytetrafluoroethylene, polypropylene, polyethylene), an elastomer (e.g., silicone, polyeurethane, and poly (ethylene-vinyl acetate)).

Embodiment 11. The system according to any one of Embodiments 1-10, wherein the matrix material comprises a matrix metal. Example metals include, e.g., Nickel, Zinc, Tin, Iron, Copper, Cobalt, Tungsten, Gold, Silver, Brass, titanium, chromium, platinum, tungsten, aluminum, magnesium and combinations (including alloys) thereof. A matrix material can also include carbon foam, carbon fiber, conductive polymers including: polyacetylene, polypyrrole, polyindole and polyaniline.

Embodiment 12. The system according to Embodiment 11, wherein the matrix metal is the same as the first metal.

Embodiment 13. The system according to any one of Embodiments 1-12, further comprising a source of the first metal. The source can be present as a bar, a particle, a flake, a wire, or in other form. As an example, when the electrolyte comprises nickel ions, a source of nickel (e.g., a nickel bar) can be present. The metal source is suitably in contact with the electrolyte.

Embodiment 14. The system according to any one of Embodiments 1-13, wherein at least some of the plurality of voids are in fluid communication with one another.

Embodiment 15. The system according to any one of Embodiments 1-14, wherein the plurality of voids are present in a periodic structure.

Embodiment 16. The system according to any one of Embodiments 1-15, wherein the electrolyte is characterized as a hydrogel electrolyte or as a solid electrolyte.

Embodiment 17. The system according to any one of Embodiments 1-16, further comprising a fluid-impervious enclosure disposed about the matrix material. Without being bound to any particular theory, such an enclosure can prevent leakage of electrolyte.

Embodiment 18. The system according to any one of Embodiments 1-17, wherein the system is comprised in a weight-bearing structural member.

Embodiment 19. The system according to any one of Embodiments 1-18, wherein the system is comprised in an impact shield, an electrode, a prosthesis, a medical implant, a flexible electrode, a contained, a protective coating, a lubricated surface, a prosthetic device, a sound absorber, a heat exchanger, a mechanical damper, a buoyant article, sporting equipment, a sandwich panel, or any combination thereof.

Embodiment 20. A method, comprising: effecting application of an electrical current to a system according to any one of Embodiments 1-19 so as to give rise to deposition of an amount of the first metal on a cathode region of the electrically conductive matrix material, the cathode region being in fluid communication with the electrolyte. Without being bound to any particular theory, the disclosed methods can be applied to, e.g., heal a fractured material, to strengthen a material before or during stress application, to add material to a region of an article (e.g., to transfer material from the right side of an article to the left side), or any combination of the foregoing.

The methods can include detection of a fracture in the matrix material. Detection of a fracture can then be used to initiate a healing process, as described herein. Suitable methods of detecting a fracture are described elsewhere herein.

Systems according to the present disclosure can be configured for autonomous fracture detection and repair. As an example, a system can be configured to detect a fracture in a matrix material; when a fracture is detected, the system can execute a healing process as described herein. A system can include one or more supplies of metal ion-containing electrolyte and/or one or more supplies of monomer-containing electrolyte. (As mentioned herein, an electrolyte can include both monomer and metal ion.) In this way, a system can be configured to detect and repair cracks, thus allowing for autonomous operation and maintenance by the system.

Embodiment 21. The method according to Embodiment 20, wherein the amount of the first metal is disposed within an opening in a conformal coating disposed on the matrix material.

Embodiment 22. A method, comprising: applying a force to a system according to any one of Embodiments 1-19 so as to give rise to a fracture of the matrix material; and effecting application of an electrical current to the system so as to give rise to deposition of an amount of the first metal on a cathode region of the electrically conductive matrix material, the cathode region being at least partially disposed along the fracture of the matrix material.

Embodiment 23. A method, comprising: effecting application of an electrical current to an electrolyte comprising a first metal ion, the application being effected so as to give rise to deposition of an amount of the first metal on a cathode region of an electrically conductive matrix material defining a plurality of voids, the cathode region being in fluid communication with the electrolyte. As described elsewhere, a source of the first metal can be present, e.g., as a bar, a particle, a flake, a wire, or in other form. As an example, when the electrolyte comprises nickel ions, a source of nickel (e.g., a nickel bar) can be present. The metal source is suitably in contact with the electrolyte.

Embodiment 24. The method according to Embodiment 23, wherein the cathode region is at least partially disposed along a fracture of the matrix. As an example, the cathode region can be an edge of the matrix, which edge at least partially defines the fracture.

Embodiment 25. The method according to Embodiment 23, wherein the cathode region of the matrix material is in fluid communication with the electrolyte by way of an opening in a conformal coating disposed on the matrix material.

Embodiment 26. The method according to Embodiment 25, further comprising forming the opening in the conformal coating.

Embodiment 27. The method according to Embodiment 26, wherein the forming comprises application of a force to the conformal coating.

Embodiment 28. The method according to Embodiment 27, wherein the force fractures the matrix material.

Embodiment 29. The method according to Embodiment 27, wherein the force fractures the matrix material before forming the opening in the conformal coating.

Embodiment 30. The method according to Embodiment 27, wherein the force fractures the conformal coating before the matrix material.

Embodiment 31. The method according to Embodiment 27, wherein the force fractures the matrix material concurrent with forming the opening in the conformal coating.

Embodiment 32. The method according to any one of Embodiments 23-31, wherein the matrix material provides the amount of the first metal deposited on the cathode region.

Embodiment 33. The method according to any one of Embodiments 23-32, wherein a source of first metal provides at least some of the amount of the first metal deposited on the cathode region.

Embodiment 34. An adaptive material, comprising: an electrically conductive matrix material defining a plurality of voids and the matrix material defining a grain size, and an amount of a first metal deposited on the matrix material, the amount of the first metal defining a grain size that differs from the grain size of the matrix material. Without being bound to any particular theory, a “healed” article according to the present disclosure comprises an amount of metal at the “healed” region that has a grain size that differs from the grain size of the matrix material.

Embodiment 35. The adaptive material according to Embodiment 34, wherein the matrix material comprises a matrix metal.

Embodiment 36. The adaptive material according to Embodiment 35, wherein (a) the matrix material defines a grain size in the range of from about 1 nanometers to about 1 millimeter, (b) wherein the amount of the first metal defines a grain in the range of from about 1 nanometer to about 100 micrometers, or any combination of (a) and (b).

Embodiment 37. The adaptive material according to any one of Embodiments 34-36, further comprising an electrolyte disposed in at least some of the voids, the electrolyte comprising at least an ion of a first metal.

Embodiment 38. The adaptive material according to any one of Embodiments 34-37, further comprising a region of conformal coating disposed on a coated region of the matrix material, the region of conformal coating being disposed so as to interrupt fluid communication between the coated region of matrix material and the electrolyte.

Embodiment 39. The adaptive material according to Embodiment 38, wherein the amount of the first metal is disposed within an opening in the conformal coating.

Embodiment 40. The adaptive material according to any one of Embodiments 34-39, wherein the amount of the first metal is disposed along a fracture of the matrix material.

Embodiment 41. A method, comprising: effecting application of a negative potential to an electrolyte comprising a first metal ion, the application being effected so as to give rise to deposition of a deposited amount of the first metal on a cathode region of an electrically conductive matrix material defining a plurality of voids, the cathode region being in fluid communication with the electrolyte, the cathode region being disposed within a fractured region of the electrically conductive matrix material; effecting application of a positive potential to an electrolyte comprising a monomer, the application being effected so as to give rise to deposition of a deposited amount of the monomer on the deposited amount of the first metal, and polymerizing the deposited amount of the monomer so as to give rise to a polymer coating on the deposited amount of the first metal.

As described elsewhere, a source of the first metal can be present, e.g., as a bar, a particle, a flake, a wire, or in other form. As an example, when the electrolyte comprises nickel ions, a source of nickel (e.g., a nickel bar) can be present. The metal source is suitably in contact with the electrolyte.

Suitable matrix materials are described elsewhere herein and can include metals, metalloids, and alloys. The metal ion can be of a metal that is present in the matrix material, but this is not a requirement. As an example, the metal ion and the matrix material can both comprise nickel. As another example, the metal ion can comprise nickel, and the matrix material can comprise zinc.

Embodiment 42. The method of Embodiment 41, wherein the first metal ion and the monomer are disposed in the same electrolyte. In such an embodiment, the matrix material can be contacted with a single electrolyte, which single electrolyte comprises both the first metal ion and the monomer.

Embodiment 43. The method of Embodiment 41, wherein the first metal ion and the monomer are disposed in different electrolytes. In this way, the matrix material can be contacted with the electrolyte that comprises the first metal ion, metal can be disposed on the matrix material to as to heal or close a fracture on the matrix material, and then the healed matrix material can be contacted with a second electrolyte, which second electrolyte comprises the monomer. The monomer can then be deposited on the metal that was disposed on the matrix material.

Embodiment 44. The method of any one of Embodiments 41-43, wherein the deposited amount of the first metal physically connects two portions of the electrically conductive matrix material. An example of this is shown in FIG. 29, which figure shows the deposited metal connecting the portions of the matrix material that were previously disconnected by a fracture.

Embodiment 45. The method of any one of Embodiments 41-44, wherein the first metal ion comprises Li, Be, Na, Mg, Al, Si, K, Ca, Sc, Ti, V, Cr, Mn, Fe, Co, Ni, Cu, Zn, Ga, Ge, As, Se, Rb, Sr, Y, Zr, Nb, Mo, Tc, Ru, Rh, Pd, Ag, Cd, In, Sn, Sb, Te, Cs, Ba, Lu, Hf, Ta, W, Re, Os, Ir, Pt, Au, Hg, Ti, Pb, Bi, Po, La, Nd, Sm, Eu, Gd, Dy, Yb, or U.

Embodiment 46. The method of any one of Embodiments 41-45, wherein the monomer is polymerized to give rise to a dielectric polymer.

Embodiment 47. The method of any one of Embodiments 41-46, wherein the deposition of a deposited amount of the first metal is characterized as deposition on two or more growth fronts until the growth fronts merge.

Embodiment 48. The method of any one of Embodiments 41-47, wherein the electrically conductive matrix material comprises a region having a cross-sectional dimension in the range of from about 0.1 to about 100 μm. As but one example, such a material can be a metal foam whereby the ligaments have diameters of from about 0.1 to about 100 μm, or from about 0.5 to about 50 μm, or from about 1 to about 25 μm, or from about 10 to about 30 μm.

For this reason, the disclosed technology is especially suitable for repairing metal materials that were prepared via metal additive manufacturing, as such materials are characterized as having fine details, often in the range of 100 to about 1000 or even 5000 nm.

It is now possible to 3D print metal structures with highly complex topologies and at a resolution as low as 100 nm. For this reason, using traditional arc welding to repair cracks within these structures becomes difficult, if not impossible. Not only would a welding torch not be able to access the area of interest (especially if it is located inside a high-tortuosity complex structure), but it also would likely melt metal in areas other than the targeted crack. Thus, the disclosed electrochemical healing technique is a substitute for traditional arc welding to access cracks in the most complex and minuscule of 3D printed metal structures. Electrochemical healing also offers greater control and accuracy during the healing process.

Embodiment 49. An adaptive material system, comprising: an electrically conductive matrix material defining a plurality of voids; an electrolyte disposed in at least some of the voids, the electrolyte comprising at least an ion of a first metal, the electrolyte further comprising an amount of a monomer that, when polymerized, gives rise to a dielectric polymer; and a source of one or both of a positive electrical potential and a negative electrical potential.

Embodiment 50. A method, comprising: effecting application of a potential to an electrolyte comprising a first metal ion, the application being effected so as to give rise to deposition of a deposited amount of the first metal on a cathode region of an electrically conductive matrix material defining a plurality of voids, the cathode region being in fluid communication with the electrolyte, the cathode region being disposed within a fractured region of the electrically conductive matrix material; effecting application of a potential to an electrolyte comprising a monomer, the application being effected so as to give rise to deposition of a deposited amount of the monomer on the deposited amount of the first metal, and polymerizing the deposited amount of the monomer so as to give rise to a polymer coating on the deposited amount of the first metal.

As described elsewhere, a source of the first metal can be present, e.g., as a bar, a particle, a flake, a wire, or in other form. As an example, when the electrolyte comprises nickel ions, a source of nickel (e.g., a nickel bar) can be present. The metal source is suitably in contact with the electrolyte.

Embodiment 51. A workpiece, comprising: an electrically conductive matrix material defining a plurality of voids, a dielectric coating surmounting the electrically conductive matrix material, an opening formed in the dielectric coating, the electrically material defining two edges physically separate from one another, the opening placing the two edges into fluid communication with the environment exterior to the dielectric coating.

An example is shown in the left-middle panel of FIG. 29, which illustrates an electrically conductive matrix material (i.e., the metal strut) defining a plurality of voids, a dielectric coating surmounting the electrically conductive matrix material, an opening formed in the dielectric coating, the electrically material defining two edges physically separate from one another, the opening placing the two edges into fluid communication with the environment exterior to the dielectric coating.

Embodiment 52. A workpiece, comprising: an electrically conductive matrix material defining a plurality of voids, the electrically material defining two edges physically separate from one another, an amount of deposited metal connecting the two edges, and a dielectric coating surmounting the matrix material and the deposited metal. Such a workpiece is shown in, e.g., the lower left panel of FIG. 29, which illustrates a strut (e.g., in a electrically conductive matrix material) having two edges separate from one another (i.e., the edges of the now-healed crack), an amount of deposited metal connecting the two edges, and a dielectric coating surmounting the strut and the metal that was used to heal the crack in the strut.

Embodiment 53. An adaptive material system, comprising: an electrically conductive matrix material defining a plurality of voids; a detection device configured to detect a fracture within the matrix material; and a supply of an electrolyte comprising at least an ion of a first metal, the electrolyte optionally comprising an amount of a monomer, and the system being configured to contact the matrix material with the electrolyte upon detection of a fracture within the matrix material, and the system being configured to apply a potential to the matrix material so as to effect deposition of an amount of the first metal onto a detected fracture. As described elsewhere, a source of the first metal can be present, e.g., as a bar, a particle, a flake, a wire, or in other form. As an example, when the electrolyte comprises nickel ions, a source of nickel (e.g., a nickel bar) can be present. The metal source is suitably in contact with the electrolyte.

Embodiment 54. The adaptive material system of Embodiment 53, further comprising a supply of an electrolyte that comprises a monomer.

Embodiment 55. The adaptive material system of any one of Embodiments 53-54, wherein the electrolyte that comprises a monomer is the electrolyte that comprises the ion of the first metal.

Embodiment 56. The adaptive material system of any one of Embodiments 53-55, wherein the system is configured to apply a potential so as to effect deposition, onto the amount of the first metal, of a polymer derived from the monomer.

Embodiment 57. An adaptive material system, comprising: a metallic matrix material; an electrolyte sealably contained within a void within the metallic matrix material, the electrolyte comprising at least an ion of a first metal; and a source of a potential, the source being configured to effect plating of the first metal onto a fractured region of the metallic matrix material.

It should be understood that in this embodiment (and in any other embodiment herein), a metal source (e.g., a nickel bar, iron particles, and the like) can be present. Without being bound to any particular theory, the metal source can act as a reference electrode.

In some embodiments, the metal ion (of the electrode) is the same metal as the metal of of the reference electrode, though this is not always a requirement. The metal ion can be the same as the metal of the metallic matrix material, though this is not a requirement. The metal of the metallic matrix material can be the same as the metal of the reference electrode, although this too is not a requirement.

As an illustrative embodiment, one can fill the voids of a metallic foam material with the metal ion-containing electrolyte, and then seal the electrolyte within the voids, e.g., via silicone or other sealant. In this manner, the electrolyte (and metal ion) are already on-site in the event of a fracture of the matrix material, and application of potential can then effect deposition of metal (from the electrolyte) onto the fractured region and heal the fracture.

Embodiment 58. The adaptive material system of Embodiment 57, further comprising a source of monomer disposed in an electrolyte, the source of monomer being in fluid communication with the fractured region of the metallic matrix material. The monomer-containing electrolyte can be introduced to the matrix material after a fracture of the matrix material is healed (via the techniques disclosed herein), and a potential can then be applied to place a passivating coating of the polymer onto the metal that has been deposited to heal the fracture in the matrix material.

Embodiment 59. An adaptive material system, comprising: a metallic matrix material; a solid or semisolid electrolyte disposed about the metallic matrix material, the solid or semisolid electrolyte comprising at least an ion of a first metal; and a source of a potential configured to effect plating of the first metal onto a fractured region of the metallic matrix material.

As described elsewhere, a source of the first metal can be present, e.g., as a bar, a particle, a flake, a wire, or in other form. As an example, when the electrolyte comprises nickel ions, a source of nickel (e.g., a nickel bar) can be present. The metal source is suitably in contact with the electrolyte.

Without being bound to any particular theory or embodiment, in this manner, the electrolyte (and metal ion) are already on-site in the event of a fracture of the matrix material, and application of potential can then effect deposition of metal (from the electrolyte) onto the fractured region and heal the fracture. The electrolyte can be, e.g., a hydrogel electrolyte, a polymer electrolyte, and the like. The electrolyte can be one that clings, attaches, adheres to, or otherwise persists at the metallic matrix material's surface. Again, in this manner, the electrolyte (and metal ion) are already on-site in the event of a fracture of the matrix material, and application of potential can then effect deposition of metal (from the electrolyte) onto the fractured region and heal the fracture.

Embodiment 60. The adaptive material system of claim 59, wherein the electrolyte comprises a polymer electrolyte.

Embodiment 61. The adaptive material system of any one of claims 59-60, further comprising a source of monomer disposed in an electrolyte, the source of monomer being in fluid communication with the fractured region of the metallic matrix material. The monomer-containing electrolyte can be one that clings, attaches, adheres to, or otherwise persists at the metallic matrix material's surface. Again, in this manner, the electrolyte (and monomer ion) are already on-site in the event of a fracture of the matrix material, and application of potential can then effect deposition of monomer (from the electrolyte) to coat the metal that has been deposited to heal the fracture, as well as to replace any other coating that may have been displaced from elsewhere on the matrix material so as to leave some of the matrix material exposed.

As described elsewhere, a source of the first metal can be present, e.g., as a bar, a particle, a flake, a wire, or in other form. As an example, when the electrolyte comprises nickel ions, a source of nickel (e.g., a nickel bar) can be present. The metal source is suitably in contact with the electrolyte.

Embodiment 62. An adaptive material system, comprising: a metallic matrix material; and an electrolyte comprising at least an ion of a first metal, the system being configured to deliver the electrolyte to a fractured region of the metallic matrix material.

As one non-limiting embodiment, a system can include a detector configured to detect the presence of a fracture or crack in a matrix material. Upon detection of this fracture or crack, the system can deliver (e.g., via pumping, spraying, dripping) the metal ion-containing electrolyte to the location of the fracture, where an appropriate potential can be applied so as to effect healing of the fracture or crack. Excess (or unconsumed or unused) electrolyte can be returned to its original location (e.g., a primary reservoir) or to another location (e.g., a secondary reservoir). The electrolyte can be a static source (e.g., a stationary reservoir), but can also be a mobile source, e.g., a movable tank or sprayer.

Embodiment 63. The adaptive material system of claim 62, further comprising a source of a potential configured to effect plating of the first metal onto the fractured region of the metallic matrix material. The source of potential can be static in location (e.g., located by the location of the fracture or crack), but can also be moveable, e.g., a movable battery or other moveable source of potential.

Embodiment 64. The adaptive material system of any one of claims 62-63, wherein the system comprises a reservoir configured to contain the electrolyte, and wherein the system is configured to deliver the electrolyte from the reservoir to the fractured region of the metallic matrix material. Delivery can be accomplished by, e.g., pumps, sprayers, and the like. Delivery can also be accomplished by mobile reservoirs, e.g., via drones or other mobile entities that can deliver electrolyte to a given location.

Embodiment 65. The adaptive material system of any one of claims 62-64, wherein the electrolyte is a flowable electrolyte.

Embodiment 66. The adaptive material system of any one of claims 62-65, wherein the system is configured to return to the reservoir electrolyte (e.g., excess electrolyte) that is delivered to the fractured region of the metallic matrix material.

Embodiment 67. The adaptive material system of any one of claims 62-66, wherein the system further comprises an electrolyte comprising at least a first monomer. Suitable monomers and electrolytes are described elsewhere herein.

Embodiment 68. The adaptive material system of claim 67, wherein the electrolyte comprises a polymer electrolyte.

### REFERENCES

T. A. Einhorn, The Cell and Molecular Biology of Fracture Healing, Clin. Orthop. Relat. Res. 355S (1998) S7-S21. doi:10.1097/00003086-199810001-00003.
T. Miclau, R. A. Schneider, B. Frank Eames, J. A. Helms, Common Molecular Mechanisms Regulating Fetal Bone Formation and Adult Fracture Repair, in: J. R. Lieberman, G. E. Friedlaender (Eds.), Bone Regen. Repair Biol. Clin. Appl., Humana Press, Totowa, N.J., 2005: pp. 45-55. doi:10.1385/1-59259-863-3:045.
D. Taylor, J. G. Hazenberg, T. C. Lee, Living with cracks: Damage and repair in human bone, Nat. Mater. 6 (2007) 263-268. doi:10.1038/nmat1866.
K. M. Hinkley, Self-Healing in Mollusks, Lessons from Biology, University of Washington, 2011. https://search.proquest.com/docview/905466185.
J.-F. M. Barthelemy, R. T. Haftka, Approximation concepts for optimum structural design—a review, Struct. Optim. 5 (1993) 129-144. doi:10.1007/BF01743349.
N. Aage, E. Andreassen, B. S. Lazarov, O. Sigmund, Giga-voxel computational morphogenesis for structural design, Nature. 550 (2017) 84-86. doi:10.1038/nature23911.
M. F, K. D. E, Optimum structural design with failure probability constraints, AIAA J. 5 (1967) 1152-1158. doi:10.2514/3.4152.
J. N. Reddy, An Introduction to Nonlinear Finite Element Analysis: with applications to heat transfer, fluid mechanics, and solid mechanics, Oxford University Press, 2014.
A. Sarja, Reliability principles, methodology and methods for lifetime design, Mater. Struct. Constr. 43 (2010) 261-271. doi:10.1617/s11527-009-9486-y.
M. Badalassi, L. Biolzi, G. Royer-Carfagni, W. Salvatore, Safety factors for the structural design of glass, Constr. Build. Mater. 55 (2014) 114-127. doi: 10.1016/j.conbuildmat.2014.01.005.
M. D. Hager, P. Greil, C. Leyens, S. Van Der Zwaag, U. S. Schubert, Self-healing Materials, Adv. Mater. 22 (2010) 5424-5430. doi:10.1002/adma.201003036.
R. P. Wool, Self-healing materials: a review, Soft Matter. 4 (2008) 400. doi:10.1039/b711716g.
D. G. Shchukin, Container-based multifunctional self-healing polymer coatings, Polym. Chem. 4 (2013) 4871. doi:10.1039/c3py00082f.
T. F. A. De Greef, M. M. J. Smulders, M. Wolffs, A. P. H. J. Schenning, R. P. Sijbesma, E. W. Meijer, Supramolecular polymerization, Chem. Rev. 109 (2009) 5687-5754. doi:10.1021/cr900181u.
F. Herbst, D. Döhler, P. Michael, W. H. Binder, Self-healing polymers via supramolecular forces, Macromol. Rapid Commun. 34 (2013) 203-220. doi:10.1002/marc.201200675.
T. J. Wallin, J. H. Pikul, S. Bodkhe, B. N. Peele, B. C. Mac Murray, D. Therriault, B. W. McEnerney, R. P. Dillon, E. P. Giannelis, R. F. Shepherd, Click chemistry stereolithography for soft robots that self-heal, J. Mater. Chem. B. 5 (2017) 6249-6255. doi:10.1039/C7TB01605K.
A. S. Farle, C. Kwakernaak, S. van der Zwaag, W. G. Sloof, A conceptual study into the potential of Mn+1AXn-phase ceramics for self-healing of crack damage, J. Eur. Ceram. Soc. 35 (2015) 37-45. doi:10.1016/j.jeurceramsoc.2014.08.046.
W. G. Sloof, R. Pei, S. A. McDonald, J. L. Fife, L. Shen, L. Boatemaa, A. S. Farle, K. Yan, X. Zhang, S. Van Der Zwaag, P. D. Lee, P. J. Withers, Repeated crack healing in MAX-phase ceramics revealed by 4D in situ synchrotron X-ray tomographic microscopy, Sci. Rep. 6 (2016) 1-9. doi:10.1038/srep23040.
S. Li, G. Song, K. Kwakernaak, S. van der Zwaag, W. G. Sloof, Multiple crack healing of a Ti2AlC ceramic, J. Eur. Ceram. Soc. 32 (2012) 1813-1820. doi:10.1016/j.jeurceramsoc.2012.01.017.
B. Grabowski, C. C. Tasan, Self-healing metals, in: M. D. Hager, S. van der Zwaag, U. S. Schubert (Eds.), Self-Healing Mater., Springer, 2016. doi:10.1007/978-3-319-32778-5.
J. B. Ferguson, B. F. Schultz, P. K. Rohatgi, Self-healing metals and metal matrix composites, JOM. 66 (2014) 866-871. doi:10.1007/s11837-014-0912-4.
K. Laha, J. Kyono, S. Kishimoto, N. Shinya, Beneficial effect of B segregation on creep cavitation in a type 347 austenitic stainless steel, Scr. Mater. 52 (2005) 675-678. doi:10.1016/j.scriptamat.2004.11.016.
G. Q. Xu, M. J. Demkowicz, Healing of nanocracks by disclinations, Phys. Rev. Lett. 111 (2013) 1-4. doi:10.1103/PhysRevLett.111.145501.
J. C. Barbour, Diffusivity of Ni in an amorphous Ni—Zr alloy, Phys. Rev. Lett. 55 (1985) 2872-2875. doi:10.1103/PhysRevLett.55.2872.
X. G. Zheng, Y.-N. Shi, K. Lu, Electro-healing Cracks in Nickel, Mater. Sci. Eng. A. 561 (2012) 52-59. doi:10.1016/j.msea.2012.10.080.
X. G. Zheng, Y.-N. Shi, K. Lu, Evaluating the Performance of 2-Mercapto-5-Benzimidazolesulfonic Acid in Controllable Electro-Healing Cracks in Nickel, J. Electrochem. Soc. 162 (2015) D222-D228. doi:10.1149/2.1021506jes.
X. G. Zheng, Y.-N. Shi, K. Lu, The Combination Addition of 2-Mercapto-5-benzimidazolesulfonic Acid and Thiourea to Watts Bath in Controllable Electro-Healing Cracks in Nickel, J. Electrochem. Soc. 163 (2016) D349-D354. doi:10.1149/2.0231608jes.
X. Zheng, Y. Shi, K. Lu, An Investigation on Polyethyleneimine and Saccharin on Controllable Electro-Healing Cracks in Nickel, J. Electrochem. Soc. 160 (2014) D289-D293. doi:10.1149/2.140306jes.
P. C. Andricacos, C. Uzoh, J. O. Dukovic, J. Horkans, H. Deligianni, Damascene copper electroplating for chip interconnections, IBM J. Res. Dev. 42 (1998) 567-574. doi:10.1147/rd.425.0567.
R. Rosenberg, D. C. Edelstein, C. Hu, K. P. Rodbell, Copper Metallization for High Performance Silicon Technology, Annu. Rev. Mater. Sci. 30 (2000) 229-262. doi:10.1146/annurev.matsci.30.1.229.
L. J. Gibson, M. F. Ashby, Cellular Solids: Structure and Properties, 2^{nd} ed., Cambridge University Press, 1997.
B. Vermang, Aluminum oxide as negatively charged surface passivation for industrial crystalline silicon solar cells, Katholieke Universiteit Leuven, 2012.
M. D. Anderson, B. Aitchison, D. C. Johnson, Corrosion Resistance of Atomic Layer Deposition-Generated Amorphous Thin Films, ACS Appl. Mater. Interfaces. 8 (2016) 30644-30648. doi:10.1021/acsami.6b11231.
S. Mirhashemihaghighi, J. wiatowska, V. Maurice, A. Seyeux, L. H. Klein, E. Harkonen, M. Ritala, P. Marcus, Electrochemical and Surface Analysis of the Corrosion Protection of Copper by Nanometer-Thick Alumina Coatings Prepared by Atomic Layer Deposition, J. Electrochem. Soc. 162 (2015) C377-C384. doi:10.1149/2.0081508jes.
A. Hankin, Electrochemical recovery of nickel from nickel sulfamate plating effluents, Imperial College London, 2011. https://spiral.imperial.ac.uk/bitstream/10044/1/9241/1/Hankin-A-2012-PhD-Thesis.pdf.
J. Newman, K. E. Thomas-Alyea, Electrochemical Systems, 3rd ed., Wiley-Interscience, 2004.
E. Dickinson, Theory of Current Distribution, COMSOL Blog. (2014). https://www.comsol.com/blogs/theory-current-distribution/(accessed Apr. 15, 2018).
A. J. Bard, L. R. Faulkner, Electrochemical Methods: Fundamentals and Applications, 2nd ed., Wiley, 2001. doi:10.1016/B978-0-12-381373-2.00056-9.
M. Pfaffe, Which Current Distribution Interface to Use?, COMSOL Blog. (2014). https://www.comsol.com/blogs/current-distribution-interface-use/.
U. S. Mohanty, B. C. Tripathy, P. Singh, S. C. Das, Effect of pyridine and its derivatives on the electrodeposition of nickel from aqueous sulfate solutions Part II: Polarization behaviour, J. Appl. Electrochem. 31 (2001) 969-972.
J. Schiøtz, A Maximum in the Strength of Nanocrystalline Copper, Science (80-.). 301 (2003) 1357-1359. doi:10.1126/science.1086636.
C. Xiao, R. A. Mirshams, S. H. Whang, W. M. Yin, Tensile Behavior and Fracture in Nickel and Carbon Doped Nanocrystalline Nickel, Mater. Sci. Eng. A. 301 (2001) 35-43.
Y. T. Zhu, X. Liao, Nanostructured Metals: Retaining Ductility, Nat. Mater. 3 (2004) 351-352. doi:10.1038/nmat1141.
G. C. Correa, B. Bao, N. C. Strandwitz, Chemical Stability of Titania and Alumina Thin Films Formed by Atomic Layer Deposition, ACS Appl. Mater. Interfaces. 7 (2015) 14816-14821. doi:10.1021/acsami.5b03278.
A. J. Haemmerli, J. C. Doll, J. Provine, R. T. Howe, D. Goldhaber-Gordon, B. L. Pruitt, Ultra-thin atomic layer deposition films for corrosion resistance, in: IEEE Transducers, Barcelona, Spain, 2013: pp. 1931-1934. doi:10.1109/Transducers.2013.6627171.
A. Tiwari, R. K. Singh Raman, Durable corrosion resistance of copper due to multi-layer graphene, Materials (Basel). 10 (2017) 1-9. doi:10.3390/ma10101112.
E. Salmi, Atomic Layer Deposited Coatings for Corrosion Protection of Metals, University of Helsinki, 2015. https://helda.helsinki.fi/bitstream/handle/10138/156985/atomicla.pdf?sequence=1.
A. Bulusu, H. Kim, D. Samet, S. Graham, Improving the stability of atomic layer deposited alumina films in aqueous environments with metal oxide capping layers, J. Phys. D. Appl. Phys. 46 (2013). doi:10.1088/0022-3727/46/8/084014.
D. Jang, L. R. Meza, F. Greer, J. R. Greer, Fabrication and deformation of three-dimensional hollow ceramic nanostructures., Nat. Mater. 12 (2013) 893-8. doi:10.1038/nmat3738.
J. H. Pikul, Z. Dai, X. Yu, H. Zhang, T. Kim, P. V Braun, W. P. King, Micromechanical devices with controllable stiffness fabricated from regular 3D porous materials, J. Micromechanics Microengineering. 24 (2014) 105006. doi:10.1088/0960-1317/24/10/105006.
D. Taylor, J. G. Hazenberg, T. C. Lee, Nat. Mater. 2007, 6, 263.
K. M. Hinkley, Self-Healing in Mollusks, Lessons from Biology, University of Washington, 2011.
N. H. van Dijk, S. van der Zwaag, Adv. Mater. Interfaces 2018, 1800226, 1.
N. Aage, E. Andreassen, B. S. Lazarov, O. Sigmund, Nature 2017, 550, 84.
J. A. Collins, H. R. Busby, G. H. Staab, Mechanical Design of Machine Elements and Machines: A Failure Prevention Perspective, Wiley, 2009.
S. R. White, N. R. Sottos, P. H. Geubelle, J. S. Moore, M. R. Kessler, S. R. Sriram, E. N. Brown, S. Viswanathan, Nature 2001, 409, 794.
Y. L. Liu, T. W. Chuo, Polym. Chem. 2013, 4, 2194.
B. J. Blaiszik, S. L. B. Kramer, S. C. Olugebefola, J. S. Moore, N. R. Sottos, S. R. White, Annu. Rev. Mater. Res. 2010, 40, 179.
F. Herbst, D. Döhler, P. Michael, W. H. Binder, Macromol. Rapid Commun. 2013, 34, 203.
P. Sanders, A. J. Young, Y. Qin, K. S. Fancey, M. R. Reithofer, R. Guillet-Nicolas, F. Kleitz, N. Pamme, J. M. Chin, Sci. Rep. 2019, 9, 1.
A. T. Matsuda, R. Kawakami, R. Namba, T. Nakajima, J. Ping, Science (80-.). 2019, 363, 504.
K. S. Toohey, N. R. Sottos, J. A. Lewis, J. S. Moore, S. R. White, Nat. Mater. 2007, 6, 581.
T. J. Wallin, J. H. Pikul, S. Bodkhe, B. N. Peele, B. C. Mac Murray, D. Therriault, B. W. McEnerney, R. P. Dillon, E. P. Giannelis, R. F. Shepherd, I Mater. Chem. B 2017, 5, 6249.
M. C. Inman, L. W. Barr, Acta Metall. 1960, 8, DOI 10.1016/0001-6160(60)90092-4.
K. W. Gao, L. J. Qiao, W. Y. Chu, Scr. Mater. 2001, 44, 1055.
C. Chen, S. Nagao, K. Suganuma, J. Jiu, H. Zhang, T. Sugahara, T. Iwashige, K. Sugiura, K. Tsuruta, Appl. Phys. Lett. 2016, 109, DOI 10.1063/1.4962333.
H. Yu, X. Liu, X. Li, A. Godbole, Metall. Mater. Trans. A Phys. Metall. Mater. Sci. 2014, 45, 1001.
I. M. Van Meerbeek, B. C. Mac Murray, J. W. Kim, S. S. Robinson, P. X. Zou, M. N. Silberstein, R. F. Shepherd, Adv. Mater. 2016, 28, 2801.
H. Song, Z. J. Wang, X. D. He, J. Duan, Sci. Rep. 2017, 7, 1.
A. Hosoi, T. Nagahama, Y. Ju, Mater. Sci. Eng. A 2012, 533, 38.
J. T. Kim, H. J. Kim, S. H. Hong, H. J. Park, Y. S. Kim, Y. J. Hwang, Y. B. Jeong, J. Y. Park, J. M. Park, B. Sarac, W. M. Wang, J. Eckert, K. B. Kim, Sci. Rep. 2018, 8, 2.
R. Marsell, T. A. Einhorn, Injury 2011, 42, 551.
L. J. Gibson, M. F. Ashby, Cellular Solids: Structure and Properties, Cambridge University Press, 1997.
X. G. Zheng, Y. N. Shi, K. Lu, Mater. Sci. Eng. A 2013, 561, 52.
G. Davies, S. Zhen, J. Mater. Sci. 1983, 18, 1899.
J. H. Pikul, S. Özerinç, B. Liu, R. Zhang, P. V. Braun, V. S. Deshpande, W. P. King, Sci. Rep. 2019, 9, 1.
W. F. Beach, Encycl. Polym. Sci. Technol. 2004, DOI 10.1002/0471440264.pst405.
J. Wu, J. Zhou, D. Zhang, in ICEM 2008 Int. Conf. Exp. Mech. 2008, 2009.
J. H. Pikul, P. V. Braun, W. P. King, J. Electrochem. Soc. 2017, 164, E3122.
C. Xiao, R. A. Mirshams, S. H. Whang, W. M. Yin, Mater. Sci. Eng. A 2001, 301, 35.
L. Jeffus, Welding: Principles and Applications, Cengage Learning, 2017.
H. Shultz, Electron Beam Welding, Abington Publishing, 1993.
D. A. Schauer, W. H. Giedt, S. M. Shintaku, Electron Beam Welding Cavity Temperature Distributions in Pure Metals and Alloys, 1978.
L. C. Montemayor, J. R. Greer, J. Appl. Mech. 2015, 82, 1.
Q. Zhang, L. Liu, C. Pan, D. Li, J. Mater. Sci. 2018, 53, 27.
E. J. Markvicka, M. D. Bartlett, X. Huang, C. Majidi, Nat. Mater. 2018, 17, 618.
T. P. Huynh, P. Sonar, H. Haick, Adv. Mater. 2017, 29, DOI 10.1002/adma.201604973.
M. Mokni, A. Kahouli, F. Jomni, J. L. Garden, E. André, A. Sylvestre, J. Phys. Chem. A 2015, 119, 9210.
K. Smalara, A. Gieltdoń, M. Bobrowski, J. Rybicki, C. Czaplewski, J. Phys. Chem. A 2010, 114, 4296.
J. F. Lancaster, The Physics of Welding, Pergamon Press, 1986.

1. An adaptive material system, comprising:
an electrically conductive matrix material defining a plurality of voids; and
an electrolyte disposed in at least some of the voids, the electrolyte comprising at least an ion of a first metal, the electrolyte optionally comprising an amount of a monomer.

2. The system according to claim 1, further comprising a source of electrical current capable of electronic communication with the electrolyte.

3. The system according to claim 1, further comprising a region of conformal coating disposed on a coated region of the matrix material, the region of conformal coating being disposed so as to interrupt fluid communication between the coated region of matrix material and the electrolyte.

4. The system according to claim 3, wherein the conformal coating is characterized as a dielectric.

5. The system according to claim 1, wherein the matrix material defines an elongation at break of unit length/length (m/m).

6. The system according to claim 5, wherein the conformal coating defines an elongation at break that is within about 5% of the elongation at break of the matrix material.

7. (canceled)

8. (canceled)

9. (canceled)

10. The system according to claim 3, wherein the conformal coating comprises a polymer, ceramic, or any combination thereof

11. The system according to claim 1, wherein the matrix material comprises a matrix metal.

12. The system according to claim 11, wherein the matrix metal is the same as the first metal.

13. The system according to claim 1, further comprising a source of the first metal.

14. The system according to claim 1, wherein at least some of the plurality of voids are in fluid communication with one another.

15. The system according to claim 1, wherein the plurality of voids are present in a periodic structure.

16. The system according to claim 1, wherein the electrolyte is characterized as a hydrogel electrolyte or as a solid electrolyte.

17. The system according to claim 1, further comprising a fluid-impervious enclosure disposed about the matrix material.

18. The system according to claim 1, wherein the system is comprised in a weight-hearing structural member.

19. The system according to claim 1, wherein the system is comprised in an impact shield.

20. A method, comprising:
effecting application of an electrical current to a system according to claim 1 so as to give rise to deposition of an amount of the first metal on a cathode region of the electrically conductive matrix material, the cathode region being in fluid communication with the electrolyte.

21. The method according to claim 20, wherein the amount of the first metal is disposed within an opening in a conformal coating disposed on the matrix material.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A method, comprising:
effecting application of a negative potential to an electrolyte comprising a first metal ion,
the application being effected so as to give rise to deposition of a deposited amount of the first metal on a cathode region of an electrically conductive matrix material defining a plurality of voids, the cathode region being in fluid communication with the electrolyte,
the cathode region being disposed within a fractured region of the electrically conductive matrix material;
effecting application of a positive potential to an electrolyte comprising a monomer,
the application being effected so as to give rise to deposition of a deposited amount of the monomer on the deposited amount of the first metal, and
polymerizing the deposited amount of the monomer so as to give rise to a polymer coating on the deposited amount of the first metal.

42. (canceled)

43. (canceled)

44. The method of claim 41, wherein the deposited amount of the first metal physically connects two portions of the electrically conductive matrix material.

45. The method of claim 41, wherein the first metal ion comprises Li, Be, Na, Mg, Al, Si, K, Ca, Se, Ti, V, Cr, Mn, Fe, Co, Ni, Cu, Zn, Ga, Ge, As, Se, Rb, Sr, Y, Zr, Nb, Mo, Tc, Ru, Rh, Pd, Ag, Cd, In, Sn, Sb, Te, Cs, Ba, Lu, Hf, Ta, W, Re, Os, Ir, Pt, Au, Hg, Ti, Pb, Bi, Po, La, Nd, Sm, Eu, Gd, Dy, Yb, or U.

46. The method of claim 41, wherein the monomer is polymerized to give rise to a dielectric polymer.

47. The method of claim 41, wherein the deposition of a deposited amount of the first metal is characterized as deposition on two or more growth fronts until the growth fronts merge.

48. (canceled)

49. An adaptive material system, comprising:
an electrically conductive matrix material defining a plurality of voids;
an electrolyte disposed in at least some of the voids, the electrolyte comprising at least an ion of a first metal, the electrolyte further comprising an amount of a monomer that, when polymerized, gives rise to a dielectric polymer; and
a source of one or both of a positive electrical potential and a negative electrical potential.

50. (canceled)

51. (canceled)

52. (canceled)

53. An adaptive material system, comprising:
an electrically conductive matrix material defining a plurality of voids;
a detection device configured to detect a fracture within the matrix material; and
a supply of an electrolyte comprising at least an ion of a first metal,
the electrolyte optionally comprising an amount of a monomer, and
the system being configured to contact the matrix material with the electrolyte upon detection of a fracture within the matrix material, and
the system being configured to apply a potential to the matrix material so as to effect deposition of an amount of the first metal onto a detected fracture.

54. The adaptive material system of claim 53, further comprising a supply of an electrolyte that comprises a monomer.

55. The adaptive material system of claim 54, wherein the electrolyte that comprises a monomer is the electrolyte that comprises the ion of the first metal.

56. The adaptive material system of claim 53, wherein the system is configured to apply a potential so as to effect deposition, onto the amount of the first metal, of a polymer derived from the monomer.

57. (canceled)

58. (canceled)

59. (canceled)

60. (canceled)

61. (canceled)

62. An adaptive material system, comprising
a metallic matrix material; and
an electrolyte comprising at least an ion of a first metal,
the system being configured to deliver the electrolyte to a fractured region of the metallic matrix material.

63. The adaptive material system of claim 62, further comprising a source of a potential configured to effect plating of the first metal onto the fractured region of the metallic matrix material.

64. (canceled)

65. (canceled)

66. The adaptive material system of claim 62, wherein the system is configured to return to a reservoir electrolyte that is delivered to the fractured region of the metallic matrix material.

67. The adaptive material system of claim 62, wherein the system further comprises an electrolyte comprising at least a first monomer.

68. (canceled)
